(19) United States
(12) Patent Application Publication
(10) Pub. No.: US 2012/0275362 A1
(43) Pub. Date: Nov. 1, 2012

(54) DEVICES FOR INTERFERENCE CONTROL SIGNALING

(75) Inventors: Kenneth J. Park, Cathlamet, WA (US); Shohei Yamada, Camas, WA (US); Ahmad Khoshnevis, Portland, OR (US); Zhanping Yin, Vancouver, WA (US); John M. Kowalski, Camas, WA (US); Sayantan Choudhury, Vancouver, WA (US)

(73) Assignee: Sharp Laboratories of America, Inc., Camas, WA (US)

(21) Appl. No.: 13/098,429

(22) Filed: Apr. 30, 2011

(51) Int. Cl. H04W 72/12; H04W 52/02

(52) U.S. Cl. 370/311; 370/329

(57) ABSTRACT

A wireless communication device configured for interference control signaling is described. The wireless communication device includes a processor and instructions stored in memory that is in electronic communication with the processor. The wireless communication device mitigates interference between a User Equipment (UE) included in the wireless communication device and another communication device included in the wireless communication device based on interference control signaling.

### TECHNICAL FIELD

The present disclosure relates generally to communication systems. More specifically, the present disclosure relates to devices for interference control signaling.

### BACKGROUND

Wireless communication devices have become smaller and more powerful in order to meet consumer needs and to improve portability and convenience. Consumers have become dependent upon wireless communication devices and have come to expect reliable service, expanded areas of coverage, and increased functionality. A wireless communication system may provide communication for a number of wireless communication devices, each of which may be serviced by a base station. A base station may be a fixed station that communicates with wireless communication devices.

As wireless communication devices have advanced, improvements in coverage, interoperability, communication capacity, speed and/or quality have been sought. For example, expanded coverage with the ability to use multiple communication technologies has been sought.

However, using multiple communication technologies may cause interference. For instance, one communication technology may interfere with the transmission and/or reception capabilities of another communication technology. As illustrated by this discussion, systems and methods that improve communication using multiple communication technologies may be beneficial.

### BRIEF DESCRIPTION OF THE DRAWINGS

FIG. 1 is a block diagram illustrating one configuration of a wireless communication device and an enhanced or evolved Node B (eNB) in which systems and methods for dynamic active period signaling may be implemented;

FIG. 2 is a flow diagram illustrating one configuration of a method for coordinating dynamic communication periods on a wireless communication device;

FIG. 3 is a flow diagram illustrating one configuration of a method for coordinating dynamic communication periods on an enhanced or evolved Node B (eNB);

FIG. 4 is a diagram illustrating one example of coordinating dynamic communication periods;

FIG. 5 is a diagram illustrating another example of coordinating dynamic communication periods for an enhanced or evolved Node B (eNB) and a User Equipment (UE);

FIG. 6 is a diagram illustrating another example of coordinating dynamic communication periods for a Station (STA);

FIG. 7 is a block diagram illustrating one configuration of a wireless communication device and an enhanced or evolved Node B (eNB) in which systems and methods for controlling interference may be implemented;

FIG. 8 is a flow diagram illustrating one configuration of a method for interference control signaling by an enhanced or evolved Node B (eNB);

FIG. 9 is a flow diagram illustrating one configuration of a method for using interference control signaling on a wireless communication device;

FIG. 10 illustrates various components that may be utilized in a User Equipment (UE);

FIG. 11 illustrates various components that may be utilized in an evolved Node B (eNB); and

FIG. 12 illustrates various components that may be utilized in a communication device.

### DETAILED DESCRIPTION

A wireless communication device configured for coordinating dynamic communication periods is disclosed. The wireless communication device includes a processor and instructions stored in memory that is in electronic communication with the processor. The wireless communication device receives a medium access control (MAC) control element (CE) from an enhanced Node B (eNB). The wireless communication device also starts a User Equipment (UE) unscheduled period.

The wireless communication device may also end the UE unscheduled period based on sending a Scheduling Request (SR), based on a UE unscheduled period timer or based on whether a station (STA) has more data to send or receive. The wireless communication may also send a UE scheduled period MAC CE.

The wireless communication device may also receive a signal from an Access Point (AP) during a station (STA) awake state. The wireless communication device may additionally determine whether the STA awake state has ended. The wireless communication device may further determine a UE scheduled period value if the STA awake state has ended. The wireless communication device may also receive a signal from an enhanced Node B (eNB) if the STA awake state has ended. Furthermore, the wireless communication device may send a UE scheduled period medium access control (MAC) control element (CE) if the STA awake state has ended.

If the STA awake state has ended, the wireless communication device may also determine a Wi-Fi sleep period value. The wireless communication device may further start a Wi-Fi sleep period. The wireless communication device may also determine whether the Wi-Fi sleep period has ended. The wireless communication device may additionally start another STA awake state if the Wi-Fi sleep period has ended. Determining whether the Wi-Fi sleep period has ended may be based on whether a UE unscheduled period MAC CE is received or based on starting a UE unscheduled period timer.

An enhanced Node B (eNB) configured for controlling dynamic communication periods is also disclosed. The eNB includes a processor and instructions stored in memory that is in electronic communication with the processor. The eNB transmits a User Equipment (UE) unscheduled period medium access control (MAC) control element (CE).

The eNB may also receive a UE scheduled period MAC CE. The eNB may additionally determine whether an eNB unscheduled period has begun. The eNB may further avoid scheduling a UE during an eNB unscheduled period. The eNB may also determine whether an eNB unscheduled period has ended.

An enhanced Node B (eNB) configured for interference control signaling is also disclosed. The eNB includes a processor and instructions stored in memory that is in electronic communication with the processor. The eNB sends an enable interference reporting command. The eNB also receives an interference report. The eNB further sends a disable interference reporting command. Additionally, the eNB sends a command to use User Equipment (UE) autonomous denial (UAD). The command to use UAD may be sent by sending the command implicitly in a message containing a start interference mitigation message, by sending the command explicitly in the message containing the start interference mitigation message or by sending the command explicitly in a message not containing the start interference mitigation message.

The eNB may also send a command to stop using UAD. The command to stop using UAD may be sent by sending the command implicitly in a message containing a stop interference mitigation message, by sending the command explicitly in the message containing the stop interference mitigation message or by sending the command explicitly in a message not containing the stop interference mitigation message.

A wireless communication device configured for using interference control signaling is also disclosed. The wireless communication device includes a processor and instructions stored in memory that is in electronic communication with the processor. The wireless communication device receives an enable interference reporting command. The wireless communication device also sends an interference report. The wireless communication device additionally receives a disable interference reporting command. Furthermore, the wireless communication device receives a command to use User Equipment (UE) autonomous denial (UAD). The command to use UAD may be received by receiving the command implicitly in a message containing a start interference mitigation message, by receiving the command explicitly in the message containing the start interference mitigation message or by receiving the command explicitly in a message not containing the start interference mitigation message.

The wireless communication device may also receive a command to stop using UAD. The command to stop using UAD may be received by receiving the command implicitly in a message containing a stop interference mitigation message, by receiving the command explicitly in the message containing the stop interference mitigation message or by receiving the command explicitly in a message not containing the stop interference mitigation message.

A method for coordinating dynamic communication periods on a wireless communication device is also disclosed. The method includes receiving a medium access control (MAC) control element (CE) from an enhanced Node B (eNB). The method further includes starting a User Equipment (UE) unscheduled period.

A method for controlling dynamic communication periods by an enhanced Node B (eNB) is also disclosed. The method includes transmitting a User Equipment (UE) unscheduled period medium access control (MAC) control element (CE).

A method for interference control signaling by an enhanced Node B (eNB) is also disclosed. The method includes sending an enable interference reporting command. The method also includes receiving an interference report. The method further includes sending a disable interference reporting command. The method additionally includes sending a command to use User Equipment (UE) autonomous denial (UAD).

A method for using interference control signaling on a wireless communication device is also disclosed. The method includes receiving an enable interference reporting command. The method also includes sending an interference report. The method further includes receiving a disable interference reporting command. The method additionally includes receiving a command to use User Equipment (UE) autonomous denial (UAD).

A wireless communication device configured for interference control signaling is also disclosed. The wireless communication device includes a processor and instructions stored in memory that is in electronic communication with the processor. The wireless communication device mitigates interference between a User Equipment (UE) included in the wireless communication device and another communication device included in the wireless communication device based on interference control signaling.

An enhanced Node B (eNB) configured for interference control signaling is also disclosed. The eNB includes a processor and instructions stored in memory that is in electronic communication with the processor. The eNB communicates interference control signaling with a User Equipment (UE) to control interference between the UE included in a wireless communication device and another communication device included in the wireless communication device.

The 3rd Generation Partnership Project, also referred to as “3GPP,” is a collaboration agreement that aims to define globally applicable technical specifications and technical reports for third and fourth generation wireless communication systems. The 3GPP may define specifications for next generation mobile networks, systems, and devices.

3GPP Long Term Evolution (LTE) is the name given to a project to improve the Universal Mobile Telecommunications System (UMTS) mobile phone or device standard to cope with future requirements. In one aspect, UMTS has been modified to provide support and specification for the Evolved Universal Terrestrial Radio Access (E-UTRA) and Evolved Universal Terrestrial Radio Access Network (E-UTRAN).

At least some aspects of the systems and methods disclosed herein may be described in relation to the 3GPP LTE and LTE-Advanced (LTE-A) standards (e.g., Release-8, Release-10 and Release-11). However, the scope of the present disclosure should not be limited in this regard. At least some aspects of the systems and methods disclosed herein may be utilized in other types of wireless communication systems.

At least some aspects of the systems and methods disclosed herein may be described in relation to the Institute of Electrical and Electronics Engineers (IEEE) 802.11 (e.g., “Wi-Fi”) standards. However, the scope of the present disclosure should not be limited in this regard. At least some aspects of the systems and methods disclosed herein may be utilized in other types of wireless communication systems.

A wireless communication device may be an electronic device used to communicate voice and/or data to one or more base stations, which in turn may communicate with a network of devices (e.g., public switched telephone network (PSTN), the Internet, etc.). In describing systems and methods herein, a wireless communication device may alternatively be referred to as a mobile station, a User Equipment (UE), an access terminal, a station (STA), a subscriber station, a mobile terminal, a remote station, a user terminal, a terminal, a subscriber unit, a mobile device, etc. Examples of wireless communication devices include cellular phones, smart phones, personal digital assistants (PDAs), laptop computers, digital audio players, netbooks, e-readers, wireless modems, etc. In 3GPP specifications, a wireless communication device is typically referred to as a User Equipment (UE). However, as the scope of the present disclosure should not be limited to the 3GPP standards, the terms “UE” and “wireless communication device” may be used interchangeably herein to mean the more general term “wireless communication device.”

In 3GPP specifications, a base station is typically referred to as a Node B, an evolved or enhanced Node B (eNB), a home enhanced or evolved Node B (HeNB) or some other similar terminology. As the scope of the disclosure should not be limited to 3GPP standards, the terms “base station,” “Node B,” “eNB,” and “HeNB” may be used interchangeably herein to mean the more general term “base station.” Furthermore, the term “base station” may be used to denote an access point (e.g., an Access Point (AP) according to IEEE 802.11 specifications). An access point may be an electronic device that provides access to a network (e.g., Local Area Network (LAN), the Internet, etc.) for wireless communication devices. The term “communication device” may be used to denote a wireless communication device, a base station and/or devices that may communicate with other communication devices.

In some cases, the terms “UE” and “STA” may be used in a logical fashion. For example, a physical wireless communication device may include a UE and a STA. In this case, a UE may comprise one or more blocks and/or modules that may be used to communicate with an eNB and a STA may comprise one or more blocks and/or modules that may be used to communicate with an AP.

The term “synchronized” and variations thereof may be used herein to denote a situation where two or more events occur in overlapping time frames. In other words, two “synchronized” events may overlap in time to some extent, but are not necessarily of the same duration. Furthermore, synchronized events may or may not begin or end at the same time.

Several acronyms may be used herein as follows. The Third Generation Partnership Project (3GPP) is a telecommunication consortium. 3G denotes the Third Generation of the 3GPP wireless and/or mobile communication specification. 4G denotes the Fourth Generation of the 3GPP wireless and/or mobile communication specification. AS stands for Access Stratum. Bluetooth (BT) is a wireless standard that is managed by the Bluetooth Special Interest Group. CN stands for Core Network. DCF denotes a wireless fidelity (Wi-Fi) Distributed Coordinated Function. DL stands for download or downlink. An Enhanced (or Evolved) Node B (eNB) is a base station conforming to the LTE specification. EOSP stands for End Of Service Period. E-UTRAN denotes the Evolved Universal Mobile Telecommunications System Terrestrial Radio Access Network.

E-UTRAN is one part of the LTE specification. FDM stands for Frequency-Division Multiplexed (or Multiplexing). GNSS denotes the Global Navigation Satellite System. HCF is a Wi-Fi Hybrid Coordinated Function (see also PCF and DCF herein). Industrial, Scientific and Medical (ISM) is a frequency band ranging from 2400 to 2483.5 megahertz (MHz). Long Term Evolution-Advanced (LTE-A) is a 3GPP 4G technology. Long Term Evolution (LTE) is a 3GPP 3G technology. MAC stands for Medium Access Control. NAS stands for Non-Access Stratum. PCF denotes Wi-Fi Point Coordinated Functions. R-11 refers to Release Number 11 of the LTE specification. RRC stands for Radio Resource Control. STA denotes a Wi-Fi Station. TDM stands for Time Division Multiplexed. UL stands for upload or uplink. U-APSD refers to Unscheduled Automatic Power Save Delivery. Wireless Fidelity (Wi-Fi) refers to IEEE 802.11 wireless networking specifications. Wi-Fi/BT indicates that one or the other or both Wi-Fi and BT transceivers are referred to.

Wi-Fi may also refer to an implementation and specification of the IEEE 802.11 wireless networking standard as determined by the Wi-Fi Alliance (http://www.wi-fi.org). In the context of the systems and methods herein, Wi-Fi may refer to those implementations of 802.11 conformant to Wi-Fi specifications in the ISM band. However, the scope of this disclosure may be applicable to other bands and should not be construed to mean only those ISM band implementations.

IEEE 802.11 defines a power save mode (PSM) that allows wireless local area network (WLAN) devices to enter into a low power consumption state by buffering frames directed to these stations at the access point (AP) while they are saving energy. Once every beacon interval, the AP sends a beacon indicating whether or not a certain station has any data buffered at the AP. Wireless stations wake up to listen to beacons at a fixed frequency (according to a Listen Interval, for example) and poll the AP to receive the buffered data by sending Power Save Polls (PS-Polls). Whenever the AP sends data to a station, it indicates whether or not there are more data frames outstanding, using a More Data (MD) bit in the data frames. A station typically goes to sleep only when it has retrieved all pending data.

The 802.11e specification provides additional and optional protocols for enhanced 802.11 MAC layer Quality of Service (QoS) such as Automatic Power Save Delivery (APSD). APSD is a more efficient power management method than legacy 802.11 Power Save Polling. Most newer 802.11 stations already support a power management mechanism similar to APSD. APSD is very useful for a Voice Over Internet Protocol (VoIP) phone, as data rates are roughly the same in both directions. Whenever voice data is sent to the AP, the AP is triggered to send the buffered voice data in the other direction. After that, the VoIP phone may enter a sleep state until more voice data has to be sent to the AP.

The IEEE 802.11 standard defines two independent power management mechanisms, depending on whether the infrastructure or ad hoc mode is used. These may allow mobile stations to enter a power-saving mode of operation where their receiver and transmitter are turned off to conserve power. Currently, most WLAN deployments use the infrastructure mode with the access arbitrated by the distributed coordination function (DCF).

In the infrastructure mode, the power-management mechanism is centralized in the access point (AP). APs may maintain a power-management status for each currently associated station that indicates in which power-management mode the station is currently operating. Stations changing the power-management mode inform the AP of this fact by using power management bits within a frame control field of the transmitted frames. The AP may buffer unicast and multicast data frames destined for any of its associated stations in power save mode (PSM). If an AP has buffered frames for a station, it may indicate this in a traffic indication map (TIM), which is sent with each beacon frame.

During the association process, every station is assigned an Association ID code (AID) by the AP. The AID indicates with a single bit in the TIM whether frames are buffered for a specific station. Stations request the delivery of their buffered frames at the AP by sending a Power Save Poll (PS-Poll). A single buffered frame for a station in Power Save Mode (PSM) is sent after a PS-Poll has been received from a station. Further PS-Poll frames from the same station are acknowledged and ignored until the frame is either successfully delivered or presumed failed due to the maximum number of retries being exceeded. This prevents a retried PS-Poll from being treated as a new request to deliver a buffered frame. Finally, APs have an aging function that deletes buffered traffic when it has been buffered for an excessive period of time.

A station may be in one of two different power states. In an “awake” power state, the station is fully powered. In a “doze” power state, the station typically does not transmit or receive and consumes very low power. While in Power Save Mode (PSM), a station awakes to listen to a beacon once every n beacons, where n is an integer greater then or equal to 1. The listen interval value used by a station is communicated to the AP in its association request. A station learns through the TIM in the beacon whether the AP has buffered any frames destined for the station while it was in the doze state. If a station sends a PS-Poll to retrieve a buffered frame, the AP may respond by sending an acknowledgement (ACK) or by sending the data frame directly. In the event that neither an ACK nor a data frame is received from the AP in response to a PS-Poll frame, the station may retry the sequence by transmitting another PS-Poll frame. In a frame control field of the frame sent in response to a PS-Poll, the AP may set a bit labeled “More Data” if there are further frames buffered for the station. The station may be required to send a PS-Poll to the AP for each data frame it receives with the More Data bit set. This may ensure that stations empty the buffer of the frames held for them at the AP.

Mobile stations may also awake at times determined by the AP, when broadcast or multicast (BC/MC) frames are to be transmitted. This time is indicated in the beacon frames as the delivery traffic indication map (DTIM) interval. If “ReceiveDTIM” is true, a station must awake at every DTIM. Note that the PSM functionality does not imply that frames sent from the station to the AP are delayed until the next beacon is received. In other words, mobile nodes (e.g., stations) wake up whenever they have data to send and may follow the regular 802.11 transmission procedure.

In order to allow users to access various networks and services ubiquitously, a wireless communication device (e.g., User Equipment (UE)) may be equipped with multiple radio transceivers. For example, a wireless communication device may be equipped with LTE, Wi-Fi, and Bluetooth (BT) transceivers as well as GNSS receivers. One of the difficulties of operating multiple transceivers simultaneously in the same device and at the same time is in trying to avoid the interference caused by one transceiver's transmissions onto another transceiver's (or possibly just a receiver as in the case of GNSS) reception. In the case of a wireless communication device, the difficulty may arise due to a very close proximity of the transceivers within the same device, whereby the transmit power of one transmitter may be much higher than the received power level of another receiver.

In-device Coexistence Interference Avoidance (IDC) is a new Study Item (SI) (in Release-10) approved by the 3GPP RAN#48 plenary (RP-100671) and it is expected that the resulting specification may be included in Release-11. This SI addresses the coexistence scenarios that LTE-A, GNSS, Bluetooth and Wi-Fi radios encounter when implemented in the same device and operating on adjacent frequencies or sub-harmonic frequencies. It should be noted that Wi-Fi and Bluetooth occupy the same frequency band (the ISM band), and may be referred to jointly as “ISM.”

The objective of this study item is to identify and investigate the suitability of methods for interference avoidance from a signaling and procedural perspective (e.g., interference detection and avoidance through scheduling of time and frequency and power resources). Additionally, if procedural methods are found to be insufficient, the study may then consider enhanced mechanisms (e.g., inter-device communications). It should be noted that the acronym “IDC” may stand for “In-Device Coexistence” and/or “In-Device Coexistence Interference Avoidance.” “In-Device Coexistence” and/or “In-Device Coexistence Interference Avoidance” may additionally or alternatively be referred to as “ICO.”

Several terms may be used herein as follows. An eNB may be a radio access part of an LTE system. A UE may be a radio terminal part of the LTE system. A UE and an eNB may be a logical pair. An AP may be a radio access part of a Wi-Fi system. A STA may be a radio terminal part of a Wi-Fi system. A STA and an AP may be a logical pair. In one configuration, a UE and a STA may be co-located in the same physical wireless communication device (e.g. handset, mobile device, laptop, etc.). A communication device may be a UE, a STA, a Bluetooth device, a GNSS receiver, an access point, a base station, etc.

Interference may be mitigated between multiple transceivers operating at the same time via a physical separation of the transmitter and receiver antennas and/or sufficient frequency separation between the transmit signal and receive signal. When frequency separation is not sufficient, filtering technologies may be applied whereby the transmitting device is able to reduce, and the receiving device is able to reject, out-of-band spurious emissions. However, for some LTE usage scenarios, filter technology may not provide sufficient rejection because of the adjacent nature of frequency band allocations for Wi-Fi/BT and LTE. As noted above, a physical separation may not be practical in a relatively small form factor. Some wireless communication devices (e.g., cellular phones, smartphones, laptops, etc.) may have a small form factor.

Solving the interference problem as it applies to wireless communication devices may require using a Time Division Multiplexed (TDM) approach (where the transmitter and/or the receiver coordinate their activity in time), a Frequency Division Multiplex (FDM) approach (where either the transmitter or the receiver or both move to another frequency), an LTE Power Control (LTE PC) approach (where the LTE transmitter reduces its output power to a point at which the receiver can operate), a UE Autonomous Denial (UAD) approach (where the UE unilaterally aborts transmission opportunities (note that UAD is a special case of TDM)) or by disabling an offending transmitter. It is possible that one or more of the above approaches may be applied to address the IDC problem.

The functions and state of the IDC feature may be partially implemented at the wireless communication device and there may or may not be a joint feature implemented at the eNB or Core Network (CN). With regard to the implementation in the wireless communication device, functions and states may be managed by a logical entity. This entity may be referred to as an “IDC Controller,” “Central Controller” (CC), “Centurial Scrutinizer” (SC) or a coordination controller. The coordination controller may have various means and modes of connectivity between it and an LTE transceiver, a Wi-Fi transceiver, a Blue Tooth transceiver, a GNSS receiver and an eNB.

In a basic mode or configuration, the coordination controller may operate in an “uncoordinated mode” whereby different technologies within the same wireless communication device operate independently without any internal coordination between each other (e.g., the coordination controller may only interact with the LTE transceiver (e.g., UE)). In a more sophisticated mode or configuration, the coordination controller may operate in a “coordinated within device only” manner, where there is an internal coordination between the different radio technologies within the same wireless communication device, which means that at least the activities of one radio is known by other radios (e.g., the coordination controller may interact with the other transceivers on the wireless communication device). In a complex mode or configuration, the coordination controller may operate in a “coordinated within device and with network” manner, whereby different radio technologies within the wireless communication device are aware of possible coexistence problems and the wireless communication device can inform the network about such problems (e.g., the coordination controller interacts with the other transceivers on the device and is able to interact with an eNB).

One configuration follows in which the systems and methods disclosed herein may be implemented. A Non Access Stratum (NAS) may be a functional layer in a wireless telecommunication protocol stack. It forms the stratum above an LTE control plane and contains the protocols that handle activities between a wireless communication device (e.g., UE) and the core network (CN). An Access Stratum (AS) may be a functional layer in the wireless telecommunication protocol stack. It contains the protocols that handle activities between the wireless communication device (e.g., UE) and the access network. A Radio Resource Control (RRC) may be the topmost layer of the AS and may be used for processing LTE RRC-type messages.

In order to allow users to access various networks and services ubiquitously, an increasing number of wireless communication devices may be equipped with multiple radio transceivers. For example, a wireless communication device may be equipped with LTE, Wi-Fi, and Bluetooth (BT) transceivers as well as GNSS receivers. One of the difficulties of operating multiple transceivers simultaneously in the same device and at the same time comes in trying to manage the impact that out-of-band spurious emissions from one radio transmitter have on another's receiver.

When multiple transceivers (e.g., ISM transceivers such as Wi-Fi and BT transceivers and an LTE transceiver) are implemented in the same device (e.g., co-located) it has been documented that ISM UL transmissions can and do interfere with LTE DL reception (see LTE 3GPP 36.816).

For 3GPP LTE-A, network-controlled UE-assisted approaches may be specified that provide for the eNB to mitigate IDC interference using one or more of an FDM approach, a TDM approach and a PC approach. At the initiation of an LTE network-controlled UE-assisted approach, the UE may send an indication to the eNB reporting the IDC problem. However, with respect to a TDM approach, it is not specified how the UE may provide the eNB with the necessary information such that the eNB may coordinate its DL transmissions with STA UL transmissions.

In one configuration, a wireless communication device on which a STA and a UE are co-located may generate a value that is used to define a doze period in the STA (e.g., a period of time during which the STA and AP are not transmitting). For convenience, this value may be referred to as a “Wi-Fi Sleep Period” (WSP). Additionally or alternatively, a wireless communication device on which a STA and a UE are co-located may generate a value that is used to define a scheduled period in the UE (e.g., a period of time during which the UE and eNB are transmitting, which may roughly mimic the WSP). For convenience, this value may be referred to as a “UE scheduled period” (USP).

By providing the eNB with the UE scheduled period (USP), the eNB may be able to coordinate its transmit and/or receive (Tx/Rx) periods with the UE such that those periods align with the STA's Wi-Fi Sleep Period (WSP). It should be noted that the wireless communication device may derive the UE scheduled period (USP) from the Wi-Fi Sleep Period (WSP) and pass it to the eNB. Thus, with assistance from the UE, the eNB may be able to mitigate the IDC problem using a TDM approach.

In one configuration, a new MAC Control Element (CE) is defined that is carried by a MAC protocol data unit (PDU) on an uplink shared channel (UL-SCH). The UL MAC CE carries the UE scheduled period (USP) from the UE to the eNB. Additionally or alternatively, a new MAC Control Element (CE) may be defined that is carried by a MAC PDU on a downlink shared channel (DL-SCH). The DL MAC CE carries a command sent by the eNB to the UE.

A period is defined. For convenience, this period is referred to herein as a “UE_Unscheduled_Period” or UUP. This period provides that the UE stop monitoring for a physical downlink control channel (PDCCH) and allows the UE to delay a Scheduling Request (SR) for UL resource allocation. The UE may begin this period when commanded to do so by the eNB. The UE may persist in the UE_Unscheduled_Period until the UE sends a signal to the eNB or a time-out timer expires. It should be noted that the PDCCH is used by the eNB to signal the scheduling of DL resource assignments and/or UL resource allocation to a UE.

Another period is defined. For convenience, this period is referred to as an “eNB_Unscheduled_Period” or EUP. This period provides that the eNB delay the scheduling of LTE protocol resources for a UE (assuming that the UE has stopped monitoring PDCCH, for example). The eNB may enter this period when the STA is about to begin an awake period. More detail is given on the STA awake period below. The eNB may persist in this period until the UE sends a signal to the eNB or a time-out timer expires. Examples of a signal from the UE to the eNB that cause the eNB to exit the eNB_Unscheduled_Period include a UE scheduled period (USP) or a Scheduling Request (on an UL-SCH, for example) to obtain a resource to inform of a UE scheduled period (USP).

The UE_Unscheduled_Period and the eNB_Unscheduled_Period may be synchronized. However, misalignment of the periods may occur in an error case.

A wireless communication device (on which a STA and a UE are co-located) may also provide a function that is logically connected to the STA and UE. This function may be known as the “Central Controller” (CC), “Central Scrutinizer” (SC) or coordination controller. The coordination controller may generate a value called the “Wi-Fi Sleep Period” (WSP) that may be used to define the doze period in the STA. The coordination controller may generate a value call the “UE scheduled period” (USP) that may be used to define the scheduled period of the UE.

In one configuration, the coordination controller may be a function or entity that is independent of the STA and UE and provides the Wi-Fi Sleep Period (WSP) to the STA and UE scheduled period (USP) to the UE. In another configuration, the coordination controller may be a feature of the STA and provide the UE with the UE scheduled period (USP). Additionally or alternatively, the coordination controller may be a feature of the UE and provide the STA with the Wi-Fi Sleep Period (WSP). The coordination controller may have global access to the state of timers used by the STA and the UE that represent their active and inactive periods (e.g., the UE_Unscheduled_Period and the Wi-Fi Sleep Period (WSP)).

During the Wi-Fi Sleep Period (WSP), the STA may not send frames to the AP and it may not receive frames sent by the AP. During the Wi-Fi Sleep Period (WSP), the AP may not send frames to the STA. Thus, the STA may be considered to be in a doze state for the duration of the Wi-Fi Sleep Period (WSP) and the AP may be considered to be in a monitor mode for the duration of the Wi-Fi Sleep Period (WSP). While in an awake state (e.g., not in a Wi-Fi Sleep Period (WSP)), the STA may send frames to the AP and may receive frames sent by the AP. During this time (not during the Wi-Fi Sleep Period (WSP)), the AP may send frames to the STA and may receive frames from the STA.

The end of a STA's awake state (e.g., when the STA's transition from the awake state to the doze state has occurred) may be indicated in one or more ways. For example, the STA may have no more data to receive from and/or to transmit to the AP and/or a UE_Unscheduled_Period_Timer may have expired. Additionally or alternatively, the end of a STA's awake state may be indicated based on one or more parameters for configuring STA traffic types, UE traffic types, Quality of Service (QoS) or others.

In response to an indication that the STA's awake state has ended, the coordination controller may generate two values in one configuration. For example, the coordination controller may generate a value called the “Wi-Fi Sleep Period” (WSP) that may be used to define a doze period in the STA. Furthermore, the coordination controller may generate a value called the “UE scheduled period” (USP) that may be used to define a scheduled period in the UE according to the Wi-Fi Sleep Period (WSP). Additionally, the coordination controller may force the STA into a Wi-Fi Sleep Period (WSP) (e.g., a doze period) after generating the Wi-Fi Sleep Period (WSP) and the UE scheduled period (USP).

In response to an indication that the STA has finished its Wi-Fi Sleep Period (WSP) or that the UE is in a UE_Unscheduled_Period (e.g., a UUP timer or “UUP_Timer” is running), the coordination controller may force the STA to exit a Wi-Fi Sleep Period (WSP), thus causing the STA to enter an awake period.

The coordination controller may provide the STA with the Wi-Fi Sleep Period (WSP). Additionally or alternatively, the coordination controller may provide the UE with the UE scheduled period (USP). The UE scheduled period (USP) may be the same as the Wi-Fi Sleep Period (WSP) or may be different from the Wi-Fi Sleep Period (WSP).

The value of the UE scheduled period (USP) represents a period of time that the eNB can expect to transmit data to the UE and/or to receive data from the UE. The value of the UE scheduled period (USP) may also represent a period of time that the eNB can expect that there will be less interference caused by Wi-Fi transmission on UE reception, and less interference caused by UE transmissions upon Wi-Fi reception.

The value of the UE scheduled period (USP) represents a period of time that the UE can expect to receive data from the eNB and to transmit data to the eNB. The value of the UE scheduled period (USP) may also represent a period of time that the UE can expect that there is less interference caused by Wi-Fi transmissions on UE reception, and less interference caused by UE transmissions on Wi-Fi reception.

In one configuration, a new MAC Control Element (CE) is defined that is carried by a MAC PDU on an UL-SCH channel. This new MAC CE may be referred to as a UE scheduled period (USP) or “UE_Scheduled_Period” MAC CE (USP MAC CE). The USP MAC CE may be identified by the MAC PDU subheader with a Logical Channel ID (LCID). The value of the LCID assigned to the USP MAC CE may be derived from the list of reserved (e.g., unused and available) LCIDs for an UL-SCH. For example, the value may range from 11 to 25 (e.g., 01011b-11001b). The LCID assigned from the list of reserved values for an UL-SCH to the USP MAC CE may be 11, for example. The USP MAC CE may have a fixed size and consists of a single octet. For example, the values carried by the USP MAC CE may range from 0 to 255d.

The value carried by the USP MAC CE from the UE to the eNB may be considered a recommendation. For example, the actual duration of the UE scheduled period (USP) may be different from one based on the value carried by the USP MAC CE, since the eNB may have ultimate control over the UE scheduled period (USP) and may terminate it at any time. The purpose of the USP MAC CE is to provide means by which the UE can transport the UE scheduled period (USP) to the eNB.

In one configuration, a new MAC Control Element (CE) is defined that is carried by a MAC PDU on a DL-SCH channel. The new MAC CE may be referred to as a UE unscheduled period (UUP) or “UE_Unscheduled_Period” MAC CE (UUP MAC CE). The UUP MAC CE may be identified by a MAC PDU subheader with a Logical Channel ID (LCID). The value of the LCID assigned to the UUP MAC CE may be derived from a list of reserved (e.g., unused and available) LCIDs for a DL-SCH. For example, the value may range from 11 to 27 (i.e. 01011b-11011b). The LCID assigned from the list of reserved values for UL-SCH to the UUP MAC CE may be 11, for example. The UUP MAC CE may have a fixed size and comprise a single octet that indicates UUP_Max. UUP_Max may be a maximum amount of time or a time limit for a UE unscheduled period (UUP). For example, the values carried by the UUP MAC CE may range from 0 to 255d. Alternatively, the UUP MAC CE may have a fixed size of zero bits and UUP_Max may be pre-defined at the UE via a semi-static configuration. The purpose of the UUP MAC CE is to provide means by which the eNB can command the UE to start a UE unscheduled period (UUP).

A period referred to as a UE unscheduled period or “UE_Unscheduled_Period” (UUP) is defined. This period provides that the UE stop monitoring for a PDCCH and that the UE is allowed to delay the Scheduling Request (SR) for UL resource allocation. The UE may begin this period when commanded to do so by the eNB. The UE may persist in the UE unscheduled period (UUP) until the UE sends a signal to the eNB or a time-out timer expires (until an amount of time represented by UUP_Max is reached, for example).

For the purpose of this disclosure, a timer is running once it is started, until it is stopped or until it expires. Otherwise, the timer is not running. A timer may be started if it is not running or restarted if it is running. A timer may be started or restarted from its initial value.

In one configuration, when the UE is in an RRC_Connected mode, the UE may function as follows. If the UE has been enabled to send the USP MAC CE to the eNB and if the UE scheduled period (USP) is available, the UE may trigger to send the USP MAC CE to the eNB with the value of the UE scheduled period (USP). If there is no UL resource available for the UE to transmit the USP MAC CE to the eNB, a Scheduling Request (SR) transmission may be triggered.

If the UE receives the UUP MAC CE from the eNB, the UE may initialize a timer (UUP_Timer) to a value (represented by UUP_Max) and start or restart the timer (UUP_Timer). It should be noted that the value of UUP_Max may be provided to the UE by the UUP MAC CE. Otherwise, the value may be semi-statically configured in the UE. If the UE sends a Scheduling Request (SR), the UE may stop the timer (UUP_Timer).

While the timer (UUP_Timer) is running, the UE may not monitor a PDCCH from the eNB. In this case, the UE may not transmit hybrid automatic repeat request (HARQ) feedback, a sounding reference signal (SRS), a channel quality indicator (CQI) a precoding matrix indicator (PMI) or a rank indicator (RI), other than a Scheduling Request (SR), to the eNB. While the timer (UUP_Timer) is not running, the UE may follow the normal procedures including discontinuous reception (DRX) procedures and monitor a PDCCH for DL assignments and UL grants.

By coordinating between Wi-Fi and LTE, the wireless communication device may decide the timing of triggering of a USP MAC CE or the timing of transmitting the Scheduling Request (SR) when the timer (UUP_Timer) is running. The Scheduling Request (SR) may be transmitted via a physical uplink control channel (PUCCH) or physical random access channel (PRACH).

Another period referred to as an eNB unscheduled period or “eNB_Unscheduled_Period” (EUP) is defined. This period provides that the eNB delay the scheduling of LTE protocol resources for a UE (assuming that the UE has stopped monitoring PDCCH, for example). The eNB may enter this period when the STA is about to begin its “awake” period. The eNB may persist in this period until the UE sends a signal to the eNB or a time-out timer expires. A signal from the UE to the eNB causing the eNB to exit the eNB unscheduled period (EUP) can be a UE scheduled period (USP) (e.g., USP MAC CE) or a Scheduling Request (SR) to obtain a resource (UL-SCH) to inform of a UE scheduled period (USP).

In one configuration, the eNB may operate as follows. If the eNB receives the USP MAC CE with a valid UE scheduled period (USP) value, the eNB may initialize a timer (USP_Timer) to the value represented by the UE scheduled period (USP). Furthermore, the eNB may start or restart the timer (USP_Timer). If the timer (USP_Timer) expires, the eNB may assume that the wireless communication device (e.g., STA) may finish being in a Wi-Fi Sleep Period (WSP), which means there is a high possibility of an IDC interference problem.

The eNB may send a UUP MAC CE at any time that eNB wants the UE to go to the UE unscheduled period (UUP). The eNB may include a value (UUP_Max) in the UUP MAC CE.

If the eNB sends a UUP MAC CE, the eNB may initialize the timer (EUP_Timer) to a value (EUP_Max). The eNB may also start or restart the timer (EUP_Timer). If the eNB detects a Scheduling Request (SR) from the UE, the eNB may stop the timer (EUP_Timer).

While the timer (EUP_Timer) is running, the eNB may not schedule protocol resources for the UE (by not transmitting any PDCCH for DL assignments or UL grants, for example). The eNB may also not receive hybrid automatic repeat request (HARQ) feedback, a sounding reference signal (SRS), a channel quality indicator (CQI) a precoding matrix indicator (PMI) or a rank indicator (RI), other than a Scheduling Request (SR) from the UE.

While the timer (EUP_Timer) is not running, the eNB may follow normal scheduling procedures, including normal discontinuous reception (DRX) procedures to schedule DL and/or UL communications with the UE. It should be noted that the UE unscheduled period (UUP) and eNB unscheduled period (EUP) may be synchronized, though misalignment may happen in an error case.

The systems and methods disclosed herein may provide several benefits. For example, the systems and methods disclosed herein may provide a solution to the problem of how to schedule LTE DL resources such that they are not interfered with by a co-located Wi-Fi device's transmissions. This may be accomplished using a TDM approach. Another benefit is that a solution is provided (using a TDM approach) to the problem of how to schedule Wi-Fi DL resources such that they are not interfered with by a co-located LTE device's transmissions.

Another benefit provided by the systems and methods disclosed herein is that they provide a solution (using a TDM approach) that is adaptable to changes in Wi-Fi transmission periods. Providing a solution (using a TDM approach) that is able to co-exist with LTE DRX procedures is another benefit.

The systems and methods disclosed herein are also beneficial in that they provide a solution (using a TDM approach) with minimal impact to existing LTE scheduling procedures in both the UE and eNB. An additional benefit is that a solution is provided (using a TDM approach) that requires very few additional protocol resources to implement.

Some potential approaches for addressing the interference problem may be divided into two categories: an LTE Network-Controlled UE-Assisted (NCUA) approach and a UE Autonomous Denial (UAD) approach (see 3GPP Technical Report 36.816). The UAD approach may involve a UE that may autonomously deny the transmission of LTE resources that would otherwise interfere with critical short-term ISM band reception events (e.g., events during BT/Wi-Fi connection setup, Wi-Fi beacon, etc.). Additionally or alternatively, the UE may autonomously deny ISM band transmissions to ensure successful reception of important LTE signaling.

The NCUA approach may involve a UE that signals to an eNB an indication of interference and possible additional information about one or more frequencies that are interfered with, the periodicity of the interference and a potential source of the interference. The NCUA approach may use one or more of a Frequency Division Multiplexed (FDM) approach and a Time Division Multiplexed (TDM) approach to address the interference (as determined by the information provided by the UE and possibly other network information). The TDM approach can be further divided into a hybrid automatic repeat request (HARQ) Process Reservation and discontinuous reception (DRX) based approaches.

In one configuration of the HARQ Process Reservation-based approach, a number of LTE HARQ processes (e.g., subframes) may be reserved for LTE upload (or uplink) and download (or downlink) traffic. The remaining subframes may be used to accommodate ISM band upload (or uplink) and download (or downlink) traffic.

In one DRX-based approach, two periods of time may be defined. The first period may be reserved for LTE upload (or uplink) and download (or downlink) traffic. The second period may be used to accommodate ISM band upload (or uplink) and download (or downlink) traffic.

There are situations where it may be useful to use a UAD approach in addition to NCUA TDM approach to facilitate Coexistence Interference Avoidance (IDC). However, an eNB currently has no control over when a UE applies UAD. This may lead to an unsynchronized scheduling between the eNB and the UE, which may result in poor utilization of protocol resources. This may be contrary to a basic LTE architectural relationship between the eNB and UE, where the eNB may know of and control all functionality related to the UEs access and/or usage of radio access network (RAN) resources.

In one configuration of the systems and methods disclosed herein, an eNB may send a command (via a dedicated radio resource control (RRC) message) to the UE that enables a UEs ability to use the UAD. Additionally or alternatively, eNB may send a command (via a dedicated RRC message) to the UE that disables the UEs ability to use the UAD.

In accordance with the systems and methods disclosed herein, an eNB may send a command (via an RRC message such as an RRCConnectionReconfiguration message) to a UE. This command may enable an ability (on the UE) to report the detection of interference caused by LTE uplink (UL) transmissions on ISM downlink (DL) receptions and/or ISM uplink (UL) transmissions on LTE downlink (DL) receptions (e.g., IDC interference). Additionally or alternatively, the eNB may send a command (via an RRC message) to the UE that disables an ability (on the UE) to report the detection of interference (e.g., IDC interference).

The UE may send (via an RRC message) a report (e.g., a MeasurementReport) regarding the detection of interference (caused by IDC interference, for example) to the eNB. The report may contain additional information about the interfered with frequency (or frequencies), the periodicity of the interference and/or the potential source of the interference (e.g., Wi-Fi or BT).

The eNB may send (via an RRC message) a data set to the UE that configures the UE and triggers the UE to start an NCUA TDM interference mitigation procedure (e.g., IDC interference mitigation procedure). The data set (e.g., configuration) may enable a DRX-based procedure or a HARQ Process Reservation-based procedure. Associated with the DRX procedure and the HARQ procedure is an ability of the UE to use UAD.

The eNB may signal the UEs ability to use UAD. In one example, this may be signaled using an implicit reception of an RRC message that contains the data set that configures the UE and triggers the UE to start an NCUA TDM interference mitigation procedure (e.g., IDC interference mitigation procedure). In another example, this may be signaled by the explicit reception of a command in the same RRC message that contains the data set that configures the UE and triggers the UE to start an NCUA TDM interference mitigation procedure (e.g., IDC interference mitigation procedure). In yet another example, this may be signaled by the explicit reception of a command in a different RRC message than the one that contains the data set that configures the UE and triggers the UE to start an NCUA TDM interference mitigation procedure (e.g., IDC interference mitigation procedure).

In one configuration, an eNB may send (via an RRC message) a command to a UE to stop the NCUA TDM interference mitigation procedure (e.g., IDC interference mitigation procedure). This command may disable a DRX-based procedure or a HARQ Process Reservation-based procedure. Associated with the DRX procedure and the HARQ procedure is an ability (of the UE) to use UAD.

The eNB may signal the UE to stop use of UAD. In one example, this may be signaled by an implicit reception of an RRC message that contains a command to stop the NCUA TDM interference mitigation procedure (e.g., IDC interference mitigation procedure). In another example, this may be signaled by an explicit reception of a command in the same RRC message that contains the command to stop the NCUA TDM interference mitigation procedure (e.g., IDC interference mitigation procedure). In yet another example, this may be signaled by the explicit reception of a command in a different RRC message than the one that contains a command to stop the NCUA TDM interference mitigation procedure (e.g., IDC interference mitigation procedure).

In one configuration, the UE may be pre-configured (at a time of manufacture, for example) with a default setting that either enables or disables the UEs ability to use UAD. However, the UE may receive from the eNB either an implicit or explicit command that overrides the default setting that specifies the UEs ability to use UAD. The systems and methods disclosed herein may provide a procedure by which an eNB may know and control the operating states of the UE with respect to the use of UAD during interference mitigation (e.g., NCUA TDM IDC interference mitigation), thus preventing potential inefficiencies in protocol resource allocations.

Various configurations are now described with reference to the Figures, where like reference numbers may indicate functionally similar elements. The systems and methods as generally described and illustrated in the Figures herein could be arranged and designed in a wide variety of different configurations. Thus, the following more detailed description of several configurations, as represented in the Figures, is not intended to limit scope, as claimed, but is merely representative of the systems and methods.

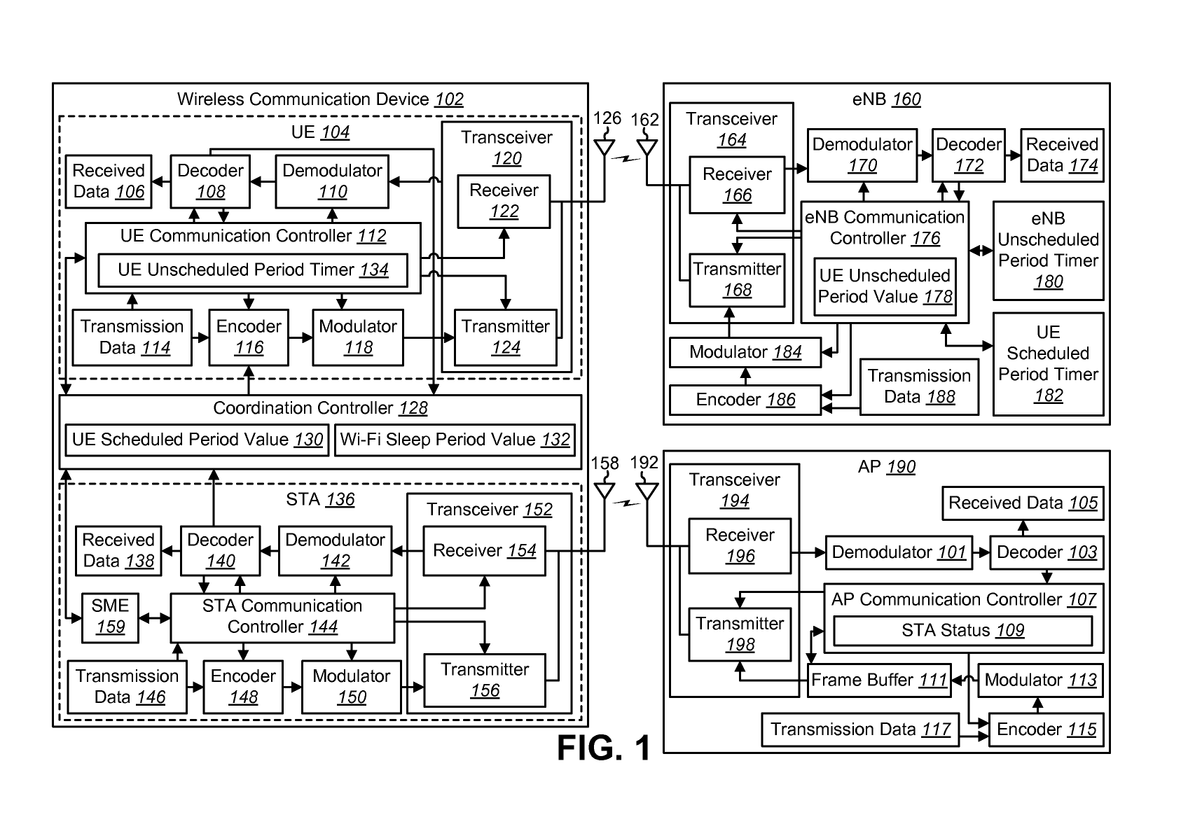

FIG. 1 is a block diagram illustrating one configuration of a wireless communication device 102 and an enhanced or evolved Node B (eNB) 160 in which systems and methods for dynamic active period signaling may be implemented. The wireless communication device 102 communicates with an enhanced or evolved Node B (eNB) 160 using one or more antennas 126. For example, the wireless communication device 102 transmits electromagnetic signals to the eNB 160 and receives electromagnetic signals from the eNB 160 using the one or more antennas 126. The eNB 160 communicates with the wireless communication device 102 using one or more antennas 162. It should be noted that the eNB 160 may be a Node B, an enhanced or evolved Node B, a home enhanced or evolved Node B (HeNB) or other kind of base station in some configurations.

The wireless communication device 102 and the eNB 160 may use one or more channels to communicate with each other. For example, the wireless communication device 102 and eNB 160 may use one or more channels (e.g., Physical Uplink Control Channel (PUCCH), Physical Uplink Shared Channel (PUSCH), Physical Random Access Channel (PRACH), Uplink Shared Channel (UL-SCH), Downlink Shared Channel (DL-SCH), Physical Downlink Control Channel (PDCCH), etc.).

The wireless communication device 102 may include a User Equipment (UE) 104, a coordination controller 128, a UE unscheduled period timer 134 and a station (STA) 136. The UE 104 may include one or more elements or components used to communicate with the eNB 160. For example, the UE 104 may include one or more transceivers 120, one or more demodulators 110, one or more decoders 108, one or more encoders 116, one or more modulators 118 and a UE communication controller 112. For instance, one or more reception and/or transmission paths may be used in the UE 104. For convenience, only a single transceiver 120, decoder 108, demodulator 110, encoder 116 and modulator 118 are illustrated, though multiple parallel elements 120, 108, 110, 116, 118 may be used depending on the configuration.

The UE transceiver 120 may include one or more receivers 122 and one or more transmitters 124. The one or more receivers 122 may receive signals from the eNB 160 using one or more antennas 126. For example, the receiver 122 may receive and downconvert signals to produce one or more received signals. The one or more received signals may be provided to a demodulator 110. The one or more transmitters 124 may transmit signals to the eNB 160 using one or more antennas 126. For example, the one or more transmitters 124 may upconvert and transmit one or more modulated signals.

The demodulator 110 may demodulate the one or more received signals to produce one or more demodulated signals. The one or more demodulated signals may be provided to the decoder 108. The wireless communication device 102 may use the decoder 108 to decode signals. The decoder 108 may produce one or more decoded signals. For example, a first UE-decoded signal may comprise received payload data 106. A second UE-decoded signal that is provided to a coordination controller 128 may comprise overhead data and/or control data. For example, the second UE-decoded signal may provide data that may be used by the coordination controller 128 to perform one or more operations. For instance, this data may include a UE unscheduled period medium access control (MAC) control element (CE) (e.g., UUP MAC CE). A third UE-decoded signal that is provided to the UE communication controller 112 may include control (e.g., scheduling) information. For example, the third UE-decoded signal may include data that is received on a Physical Downlink Control Channel (PDCCH).

The UE communication controller 112 may be used to control communication functions within the UE 104. For example, the UE communication controller 112 may control the decoder 108, the demodulator 110, the receiver 122, the transmitter 124, the modulator 118 and the encoder 116. For instance, the UE communication controller 112 may send one or more signals to the decoder 108, the demodulator 110, the receiver 122, the transmitter 124, the modulator 118 and the encoder 116. This may allow the UE communication controller 112 to schedule data transmission and/or reception, for instance.

The UE communication controller 112 may provide information to the receiver 122, demodulator 110 and/or decoder 108. This information may include instructions. For example, the UE communication controller 112 may instruct the receiver 122, demodulator 110 and/or decoder 108 to suspend operation (e.g., not monitor for a PDCCH) during a UE unscheduled period or resume operation during a UE scheduled period.

In some configurations, the UE communication controller 112 may include or be coupled to the UE unscheduled period (UUP) timer 134. In this case, the UE communication controller 112 may provide information to the coordination controller 128, such as an event or notification regarding the state of the UE unscheduled period (UUP) timer 134. For instance, the UE communication controller 112 may notify the coordination controller 128 when the UUP timer 134 is started or stopped or that the UUP timer 134 is running or stopped. In some configurations, the UE communication controller 112 may additionally or alternatively receive and follow one or more instructions from the coordination controller 128 to start, stop or reset the UUP timer 134 and/or to set a limit value of (e.g., initialize) the UUP timer 134. In other configurations, the UE communication controller 112 may autonomously control the UUP timer 134 without receiving instructions.

The encoder 116 may encode transmission data 114, information provided by the UE communication controller 112 and information provided by the coordination controller 128. For example, encoding the data 114 and/or other information may involve error detection and/or correction coding, mapping data to space, time and/or frequency resources (e.g., space-time block coding (STBC)) for transmission, etc. The UE communication controller 112 may provide scheduling information to the encoder 116, such as a Scheduling Request (SR), for example. In one configuration, the UE communication controller 112 may generate a Scheduling Request (SR) when there is data 114 for transmission. The coordination controller 128 may provide information to the encoder 116, such as a UE scheduled period (USP) medium access control (MAC) control element (CE). The encoder 116 may provide encoded data to the modulator 118.

The UE communication controller 112 may provide information to the modulator 118. This information may include instructions for the modulator 118. For example, the UE communication controller 112 may instruct the modulator 118 to suspend operation during a UE unscheduled period or resume operation during a UE scheduled period. The modulator 118 may modulate the encoded data to provide one or more modulated signals to the one or more transmitters 124.

The UE communication controller 112 may provide information to the one or more transmitters 124. This information may include instructions for the one or more transmitters 124. For example, the UE communication controller 112 may instruct the one or more transmitters 124 to suspend operation during a UE unscheduled period or resume operation during a UE scheduled period. The one or more transmitters 124 may upconvert and transmit the modulated signal(s) to the eNB 160.

The STA 136 may include one or more elements or components used to communicate with an Access Point (AP) 190. For example, the STA 136 may include one or more transceivers 152, one or more demodulators 142, one or more decoders 140, one or more encoders 148, one or more modulators 150 and a STA communication controller 144. For instance, one or more reception and/or transmission paths may be used in the STA 136. For convenience, only a single transceiver 152, decoder 140, demodulator 142, encoder 148 and modulator 150 are illustrated, though multiple parallel elements 152, 140, 142, 148, 150 may be used depending on the configuration.

The STA 136 may additionally include a Station Management Entity (SME) 159. The SME 159 may provide an interface between the coordination controller 128 and the STA 136. In one configuration, the SME 159 may be a protocol device with primitives, etc. These protocol elements may not directly control the Physical (or MAC) layer components of the STA 136. However, the protocol elements may be considered to “configure” the Physical (or MAC) layer components of the STA 136.

The SME 159 may function as a “go-between” between the coordination controller 128 and the STA communication controller 144. For instance, using the SME 159, the coordination controller 128 may obtain information to determine the current state of the STA 136, current operations being performed by the STA 136 and/or other information (e.g., variables, parameters) available in the STA 136. More specifically, the SME 159 may be an IEEE 802.11 (e.g., Wi-Fi) protocol entity that may pass STA configuration and transmission information outside of the 802.11 protocol stack to other applications or processes within the wireless communication device 102 in which the UE 104 and STA 136 reside.

In one configuration, one or more of the signals, commands, messages, pieces of information etc., described herein that are communicated between the coordination controller 128 and the STA 136 may be handled by the SME 159 (including commands, information or messages provided to the STA 136 from the coordination controller 128 or vice-versa). This may be in addition to or alternatively from any other element or entity within the STA 136 communicating with the coordination controller 128, such as the decoder 140.

The STA transceiver 152 may include one or more receivers 154 and one or more transmitters 156. The one or more receivers 154 may receive signals from the AP 190 using one or more antennas 158. For example, the receiver 154 may receive and downconvert signals to produce one or more received signals. The one or more received signals may be provided to a demodulator 142. The one or more transmitters 156 may transmit signals to the AP 190 using one or more antennas 158. For example, the one or more transmitters 156 may upconvert and transmit one or more modulated signals.

The demodulator 142 may demodulate the one or more received signals to produce one or more demodulated signals. The one or more demodulated signals may be provided to the decoder 140. The wireless communication device 102 may use the decoder 140 to decode signals.

The decoder 140 may produce one or more decoded signals. For example, a first STA-decoded signal may comprise received payload data 138 (e.g., a data frame).

A second STA-decoded signal that is provided to a coordination controller 128 may comprise overhead data and/or control data. For example, the second STA-decoded signal may provide data that may be used by the coordination controller 128 to perform one or more operations. For instance, the second STA-decoded signal may include an indication that the AP 190 has or does not have any data buffered for the STA 136 (which may be indicated in a traffic indication map (TIM)). Additionally or alternatively, one or more pieces of overhead and/or control data may be provided to the coordination controller 128 via the SME 159. For instance, whether the AP 190 has any buffered data for the STA 136 may be indicated to the coordination controller 128 via the SME 159.

A third STA-decoded signal may provide data to the STA communication controller 144 that the STA communication controller 144 may use to perform one or more operations. For instance, this data may indicate that there is more or no more payload data 138 to be received from the AP 190. In one configuration, this may be indicated in a traffic indication map (TIM) received in a beacon frame. Additionally or alternatively, this data may indicate an Acknowledgement (ACK) of a PS-Poll frame.

The STA communication controller 144 may be used to manage communications between the STA 136 and the AP 190. For example, the STA communication controller 144 may control the decoder 140, the demodulator 142, the receiver 154, the transmitter 156, the modulator 150 and the encoder 148. For instance, the STA communication controller 144 may send one or more signals to the decoder 140, the demodulator 142, the receiver 154, the transmitter 156, the modulator 150 and the encoder 148. This may allow the STA communication controller 144 to control data transmission and/or reception, for instance.

The STA communication controller 144 may provide information to the receiver 154, demodulator 142 and/or decoder 140. This information may include instructions. For example, the STA communication controller 144 may instruct the receiver 154, demodulator 142 and/or decoder 140 to reduce or suspend operation (e.g., only monitor a beacon signal once every n frames) during a Wi-Fi sleep period or resume operation while not in a Wi-Fi sleep period.

The encoder 148 may encode transmission data 146 and/or other information provided by the STA communication controller 144. For example, encoding the data 146 and/or other information may involve error detection and/or correction coding, mapping data to space, time and/or frequency resources (e.g., space-time block coding (STBC)) for transmission, etc. For instance, the STA communication controller 144 may provide information to the encoder 148 indicating a power save mode of operation. In one configuration, this information may include power management bits within a frame control field of one or more transmitted frames. Additionally, the STA communication controller 144 may provide information (e.g., a PS-Poll) to the encoder 148 indicating that the STA 136 is ready to receive a frame. This may allow the STA communication controller 144 to manage when frames are received, for instance. Additionally, the STA communication controller 144 may provide an Acknowledgement (ACK) to the encoder 148 indicating that a data frame has been received. The encoder 148 may provide encoded data to the modulator 150.

The STA communication controller 144 may provide information to the modulator 150. This information may include instructions for the modulator 150. For example, the STA communication controller 144 may instruct the modulator 150 to suspend operation during a Wi-Fi sleep period or resume operation when not in a Wi-Fi sleep period. The modulator 150 may modulate the encoded data to provide one or more modulated signals to the one or more transmitters 156.

The STA communication controller 144 may provide information to the one or more transmitters 156. This information may include instructions for the one or more transmitters 156. For example, the STA communication controller 144 may instruct the one or more transmitters 156 to suspend operation during a Wi-Fi sleep period or resume operation when not in a Wi-Fi sleep period. The one or more transmitters 156 may upconvert and transmit the modulated signal(s) to the AP 190.

It should be noted that each of the elements or components included in the wireless communication device 102 may be implemented in hardware, software or a combination of both. For example, the coordination controller 128 may be implemented in hardware, software or a combination of both.

The coordination controller 128 may be used to coordinate UE 104 communications and STA 136 communications. For example, the coordination controller 128 may allow the UE 104 to communicate with the eNB 160 during a Wi-Fi sleep period (WSP) and/or during a UE scheduled period (USP). Additionally, the coordination controller 128 may allow the STA 136 to communicate with the AP 190 during a UE unscheduled period (UUP) (but not during the Wi-Fi sleep period (WSP), for example). The coordination controller 128 may handle transitions between different periods based on signaling and/or the use of a UE unscheduled period (UUP) timer 134.

In one configuration, the coordination controller 128 may be included in the UE 104. For example, the functionality provided by the coordination controller 128 may be provided by the UE 104 in some configurations. In another configuration, the coordination controller 128 may be included in the STA 136. In yet another configuration, the coordination controller 128 may not be included in the UE 104 or the STA 136.

The eNB 160 may include one or more elements or components used to communicate with the wireless communication device 102 (e.g., UE 104). For example, the eNB 160 may include one or more transceivers 164, one or more demodulators 170, one or more decoders 172, one or more encoders 186, one or more modulators 184 and an eNB communication controller 176. For instance, one or more reception and/or transmission paths may be used in the eNB 160. For convenience, only a single transceiver 164, decoder 172, demodulator 170, encoder 186 and modulator 184 are illustrated, though multiple parallel elements 164, 172, 170, 186, 184 may be used depending on the configuration. It should be noted that the eNB 160 may be coupled to a network (e.g., the Internet, Public Switched Telephone Network (PSTN), etc.) and may serve to relay data between the wireless communication device 102 (e.g., UE) and the network.

The eNB transceiver 164 may include one or more receivers 166 and one or more transmitters 168. The one or more receivers 166 may receive signals from the wireless communication device 102 using one or more antennas 162. For example, the receiver 166 may receive and downconvert signals to produce one or more received signals. The one or more received signals may be provided to a demodulator 170. The one or more transmitters 168 may transmit signals to the wireless communication device 102 using one or more antennas 162. For example, the one or more transmitters 168 may upconvert and transmit one or more modulated signals.

The demodulator 170 may demodulate the one or more received signals to produce one or more demodulated signals. The one or more demodulated signals may be provided to the decoder 172. The eNB 160 may use the decoder 172 to decode signals. The decoder 172 may produce one or more decoded signals. For example, a first eNB-decoded signal may comprise received payload data 174. A second eNB-decoded signal that is provided to an eNB communication controller 176 may comprise overhead data and/or control data. For example, the second eNB-decoded signal may provide data that may be used by the eNB communication controller 176 to perform one or more operations. For instance, this data may indicate that the wireless communication device 102 has requested resources for communication (using a Scheduling Request (SR), for example). Additionally or alternatively, this data may include a UE scheduled period (USP) medium access control (MAC) control element (CE). For instance, the USP MAC CE may indicate a recommendation for a period of communications between the eNB 160 and the wireless communication device 102.

The USP MAC CE may be carried by a MAC PDU on an UL-SCH channel. In some configurations, the USP MAC CE may be referred to as a “UE_Scheduled_Period MAC CE” (USP MAC CE). The USP MAC CE may be identified by the MAC PDU subheader with a Logical Channel ID (LCID). The value of the LCID assigned to the USP MAC CE may be derived from a list of reserved (e.g., unused and available) LCIDs for an UL-SCH. For example, the value may range from 11 to 25 (e.g., 01011b-11001b). The LCID assigned from the list of reserved values for an UL-SCH to the USP MAC CE may be 11, for example. The USP MAC CE may have a fixed size and may comprise a single octet. For example, the values carried by the USP MAC CE may range from 0 to 255d.

The value carried by the USP MAC CE from the wireless communication device 102 to the eNB 160 may be considered a recommendation. For example, the actual duration of the UE scheduled period (USP) may be different from one based on the value carried by the USP MAC CE, since the eNB 160 may have ultimate control over the UE scheduled period (USP) and may terminate it at any time. The purpose of the USP MAC CE is to provide means by which the wireless communication device 102 (e.g., UE 104) can transport the UE scheduled period (USP) to the eNB 160.

The eNB communication controller 176 may be used to perform scheduling functions. For example, the eNB communication controller 176 may control the decoder 172, the demodulator 170, the receiver 166, the transmitter 168, the modulator 184 and the encoder 186. For instance, the eNB communication controller 176 may send one or more signals to the decoder 172, the demodulator 170, the receiver 166, the transmitter 168, the modulator 184 and the encoder 186. This may allow the eNB communication controller 176 to control data transmission and/or reception, for instance.

The eNB communication controller 176 may provide information to the receiver 166, demodulator 170 and/or decoder 172. This information may include instructions. For example, the eNB communication controller 176 may instruct the receiver 166, demodulator 170 and/or decoder 172 to reduce or suspend operations corresponding to the wireless communication device 102 during an eNB unscheduled period (EUP) and/or during a UE unscheduled period (UUP). It should be noted that the eNB 160 may continue to communicate with other wireless communication devices during the eNB unscheduled period (EUP) corresponding to the wireless communication device 102 and/or during the UE unscheduled period (UUP).

The encoder 186 may encode transmission data 188 and/or other information provided by the eNB communication controller 176. For example, encoding the data 188 and/or other information may involve error detection and/or correction coding, mapping data to space, time and/or frequency resources (e.g., space-time block coding (STBC)) for transmission, etc. For instance, the eNB communication controller 176 may provide information to the encoder 186, such as a UE unscheduled period (UUP) medium access control (MAC) control element (CE). Additionally, the eNB communication controller 176 may provide control information (e.g., information for a PDCCH) to the encoder 186. This may allow the eNB communication controller 176 to manage when the eNB 160 communicates with the wireless communication device 102. The encoder 186 may provide encoded data to the modulator 184.

The UUP MAC CE may be carried by a MAC PDU on a DL-SCH channel. In some configurations, the UUP MAC CE may be referred to as a “UE_Unscheduled_Period MAC CE” (UUP MAC CE). The UUP MAC CE may be identified by a MAC PDU subheader with a Logical Channel ID (LCID). The value of the LCID assigned to the UUP MAC CE may be derived from a list of reserved (e.g., unused and available) LCIDs for a DL-SCH. For example, the value may range from 11 to 27 (i.e. 01011b-11011b). The LCID assigned from the list of reserved values for UL-SCH to the UUP MAC CE may be 11, for example. The UUP MAC CE may have a fixed size and may comprise a single octet that indicates a UE unscheduled period limit or maximum (e.g., UUP_Max). For example, the values carried by the UUP MAC CE may range from 0 to 255d. Alternatively, the UUP MAC CE may have a fixed size of zero bits and UUP_Max may be pre-defined at the wireless communication device 102 via a semi-static configuration. The purpose of the UUP MAC CE is to provide means by which the eNB 160 can command the wireless communication device 102 to start a UE unscheduled period (UUP).

The eNB communication controller 176 may provide information to the modulator 184. This information may include instructions for the modulator 184. For example, the eNB communication controller 176 may instruct the modulator 184 to suspend operation during an eNB unscheduled period (EUP) and/or during a UE unscheduled period (UUP) or resume operation during an eNB scheduled period and/or UE scheduled period (USP). The modulator 184 may modulate the encoded data to provide one or more modulated signals to the one or more transmitters 168.

The eNB communication controller 176 may provide information to the one or more transmitters 168. This information may include instructions for the one or more transmitters 168. For example, the eNB communication controller 176 may instruct the one or more transmitters 168 to suspend operation corresponding to the wireless communication device 102 during an an eNB unscheduled period (EUP) and/or during a UE unscheduled period (UUP) or resume operation during an eNB scheduled period and/or a UE scheduled period (USP). The one or more transmitters 168 may upconvert and transmit the modulated signal(s) to the wireless communication device 102.

It should be noted that each of the elements or components included in the eNB 160 may be implemented in hardware, software or a combination of both. For example, the eNB communication controller 176 may be implemented in hardware, software or a combination of both.

The eNB communication controller 176 may be used to coordinate communications with the wireless communication device 102. For example, the eNB communication controller 176 may allow the eNB 160 to communicate with the UE 104 during an eNB scheduled period and/or during a UE scheduled period (USP) (e.g., during a time that is not a UE unscheduled period (UUP) and/or an eNB unscheduled period (EUP)). The eNB communication controller 176 may handle transitions between different periods based on signaling, the use of an eNB unscheduled period (EUP) timer 180 and/or a UE scheduled period (USP) timer 182.

The AP 190 may include one or more elements or components used to communicate with the wireless communication device 102. For example, the AP 190 may include one or more transceivers 194, one or more demodulators 101, one or more decoders 103, one or more encoders 115, one or more modulators 113, a frame buffer 111 and an AP communication controller 107. For instance, one or more reception and/or transmission paths may be used in the AP 190. For convenience, only a single transceiver 194, decoder 103, demodulator 101, encoder 115, modulator 113 and frame buffer 111 are illustrated, though multiple parallel elements 194, 103, 101, 115, 113, 111 may be used depending on the configuration. It should be noted that the AP 190 may be coupled to a network (e.g., a Local Area Network (LAN), the Internet, etc.) and may serve to relay data between the wireless communication device 102 (e.g., STA 136) and the network.

The AP transceiver 194 may include one or more receivers 196 and one or more transmitters 198. The one or more receivers 196 may receive signals from the wireless communication device 102 using one or more antennas 192. For example, the receiver 196 may receive and downconvert signals to produce one or more received signals. The one or more received signals may be provided to a demodulator 101. The one or more transmitters 198 may transmit signals to the wireless communication device 102 using one or more antennas 192. For example, the one or more transmitters 198 may upconvert and transmit one or more modulated signals.

The demodulator 101 may demodulate the one or more received signals to produce one or more demodulated signals. The one or more demodulated signals may be provided to the decoder 103.

The AP 190 may use the decoder 103 to decode signals. The decoder 103 may produce one or more decoded signals. For example, a first AP-decoded signal may comprise received payload data 105. A second AP-decoded signal that is provided to an AP communication controller 107 may comprise overhead data and/or control data. For example, the second AP-decoded signal may provide data that may be used by the AP communication controller 107 to perform one or more operations. For instance, this data may include power management bits (in a frame control field of one or more received frames) that indicate a power management mode that the STA 136 is operating in. These power management bits may be used to determine a STA status 109 for the STA 136. Additionally or alternatively, this data may include PS-Poll frame indicating that the STA 136 is requesting a frame. Additionally or alternatively, the overhead data and/or control data may include an Acknowledgement (ACK) indicating that the wireless communication device 102 has successfully received a (data) frame.

The AP communication controller 107 may be used to control communications between the AP 190 and the wireless communication device 102 (e.g., STA 136). The AP communication controller 107 may include a STA status 109. The STA status 109 indicates a power management status of the STA 136 (e.g., a power management mode that the STA 136 is operating in).

In one configuration, the AP communication controller 107 may control the transmitter 198 and the frame buffer 111. For instance, the AP communication controller 107 may send one or more signals to the transmitter 198 and the frame buffer 111. This may allow the AP communication controller 107 to control data transmission, for instance.

The AP communication controller 107 may manage frames destined for the wireless communication device 102 (e.g., STA 136). For example, the AP communication controller 107 may send a signal to a frame buffer 111 that instructs the frame buffer 111 to hold (payload data 117) frames destined for the wireless communication device 102. This may be done if the STA status 109 indicates that the wireless communication device 102 is in a power save mode. The frame buffer 111 may notify the AP communication controller 107 if any frames are being buffered or held for the wireless communication device 102. The AP communication controller 107 may place an indication in a traffic indication map (TIM) indicating that one or more frames are being held for the STA 136.

The encoder 115 may encode transmission data 117 and/or other information provided by the AP communication controller 107. For example, encoding the data 117 and/or other information may involve error detection and/or correction coding, mapping data to space, time and/or frequency resources (e.g., space-time block coding (STBC)) for transmission, etc. For instance, the AP communication controller 107 may provide information to the encoder 115, such as a traffic indication map (TIM) in a beacon frame. Additionally, the AP communication controller 107 may provide an Acknowledgement (ACK) to the encoder 115 when a PS-Poll frame has been successfully received. This may allow the AP communication controller 107 to manage when the AP 190 communicates with the wireless communication device 102. The encoder 115 may provide encoded data to the modulator 113.

The modulator 113 may modulate the encoded data to provide one or more modulated signals to the one or more frame buffers 111 or to the one or more transmitters 198. For example, a frame buffer 111 may hold payload data 117 frames, but may not hold overhead or control frames (e.g., beacons, ACKs, etc.).

The AP communication controller 107 may provide information to the one or more transmitters 198. This information may include instructions for the one or more transmitters 198. For example, the AP communication controller 107 may instruct the one or more transmitters 198 to suspend operation corresponding to the wireless communication device 102 (e.g., STA 136) during a doze period (e.g., Wi-Fi sleep period) or resume operation outside of the doze period (e.g., Wi-Fi sleep period). The one or more transmitters 198 may upconvert and transmit the modulated signal(s) to the wireless communication device 102. It should be noted that the AP 190 may continue to communicate with other wireless communication devices during the doze period (e.g., Wi-Fi sleep period).

It should be noted that each of the elements or components included in the AP 190 may be implemented in hardware, software or a combination of both. For example, the AP communication controller 107 may be implemented in hardware, software or a combination of both.

In order to illustrate the functionality of the systems and methods herein, one example is given hereafter. In giving this example, however, it should be noted that operation may begin in differing periods. In this example, assume that the STA 136 is initially communicating with the AP 190. For instance, the STA 136 may transmit PS-Polls to the AP 190 and may receive frames from the AP 190.

The coordination controller 128 may then transition the wireless communication device 102 into a Wi-Fi sleep period (WSP) and/or UE scheduled period (USP). This transition may be triggered by one or more events. For example, the coordination controller 128 may detect that the STA 136 currently has no more data 138 (as indicated by the TIM, for example) to receive from the AP 190 and has no more data 146 to transmit to the AP 190 (which may be indicated by the SME 159). Additionally or alternatively, the coordination controller 128 may detect that the UE 104 has sent or may send a Scheduling Request (SR) to the eNB 160. Additionally or alternatively, the coordination controller 128 may detect that the UE unscheduled period (UUP) timer 134 has expired.

At this point, the coordination controller 128 may determine a new Wi-Fi sleep period (WSP) value 132 and a new UE scheduled period (USP) value 130. In some configurations, this determination may be based on a STA 136 Quality of Service (QoS). For example, this may be determined using MAC signaling being made available via a Station Management Entity (SME) 159.

The coordination controller 128 may then send a signal (e.g., command) to the STA communication controller 144 (via the SME 159, for example) that instructs the STA 136 to enter into a doze mode (e.g., the Wi-Fi sleep period (WSP)). The STA communication controller 144 may signal one or more of the decoder 140, demodulator 142, receiver 154, encoder 148, modulator 150 and transmitter 156 to stop sending communications to and to stop receiving communications from the AP 190.

If the UE unscheduled period (UUP) timer 134 has not stopped (e.g., has not expired), the coordination controller 128 or the UE communication controller 112 may stop the UUP timer 134 at this point (because of an SR or because the STA 136 has no more data to send or receive, for example). At this point, the UE 104 may send a UE scheduled period (USP) MAC CE. For example, the coordination controller 128 may generate a USP MAC CE that it 128 provides to the encoder 116. The USP MAC CE may then be transmitted to the eNB 160.

The eNB 160 may transition to normal scheduling procedures based on one or more events or triggers. For example, the eNB 160 may receive a Scheduling Request (SR) from the wireless communication device 102 in order to send the UE scheduled period MAC CE. Additionally or alternatively, the eNB unscheduled period (EUP) timer 180 may have expired. The eNB communication controller 176 may stop the EUP timer 180 if it has not stopped (e.g., expired) already.

At this point, the eNB 160 may start or continue normal scheduling procedures. The eNB 160 may receive the UE scheduled period MAC CE. The eNB communication controller 176 may start (or restart) the UE scheduled period (USP) timer 182.

At some time before the USP timer 182 expires, the eNB communication controller 176 (e.g., scheduling controller) may generate the UE unscheduled period (UUP) value 178. The UUP value 178 may be used to generate a UE unscheduled period (UUP) MAC CE. The eNB 160 may transmit the UUP MAC CE to the wireless communication device 102. The eNB communication controller 176 may then start the eNB unscheduled period (UUP) timer 180.

At this point, the eNB 160 may transition to an eNB unscheduled period (EUP), which may correspond to the UE unscheduled period (UUP). The eNB communication controller 176 may signal one or more of the receiver 166, demodulator 170, decoder 172, encoder 186, modulator 184 and transmitter 168 to prevent or avoid receiving signals from the wireless communication device 102 (except for a possible Scheduling Request (SR)) and to prevent or avoid transmitting signals (e.g., PDCCHs, etc.) specific to the wireless communication device 102.

The wireless communication device 102 may receive the UE unscheduled period (UUP) MAC CE from the eNB 160. The coordination controller 128 or the UE communication controller 112 may start (or restart) the UE unscheduled period (UUP) timer 134. At this point, the wireless communication device 102 transitions to a UE unscheduled period (UUP). The coordination controller 128 may indicate this transition to the UE communication controller 112. The UE communication controller 112 may instruct one or more of the decoder 108, demodulator 110, receiver 122, encoder 116, modulator 118 and transmitter 124 to stop receiving any signals from the eNB 160 and to stop transmitting any signals to the eNB 160. The UE unscheduled period (UUP) may continue until the UE unscheduled period timer 134 expires, until the STA 136 has no more data 138 to receive from and no more data 146 to transmit to the AP 190 and/or until the UE 104 is triggered to make a Scheduling Request (SR).

When the coordination controller 128 detects that the UE unscheduled period timer 134 has started or that a Wi-Fi sleep period (WSP) has ended, the coordination controller 128 may signal the STA communication controller 144 (via the SME 159, for example), causing the STA 136 to exit a doze state (e.g., the Wi-Fi sleep period (WSP)). When exiting the Wi-Fi sleep period (WSP), the STA 136 may receive communications from the AP 190 and/or may transmit communications to the AP 190.

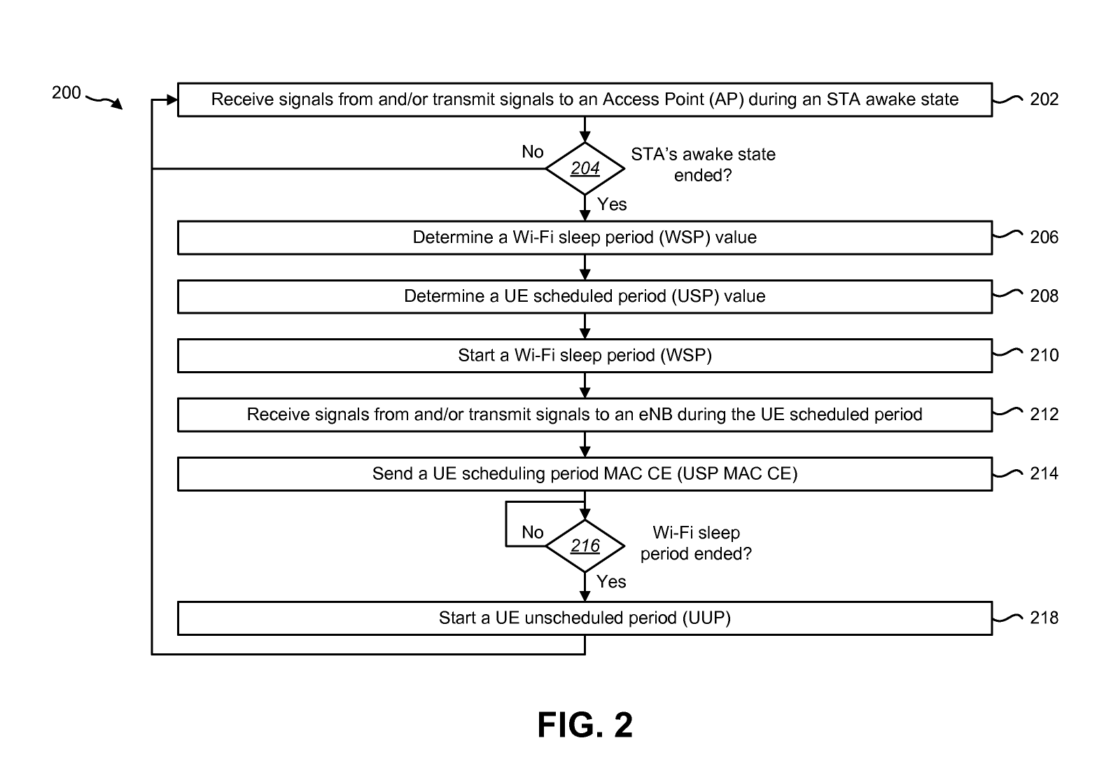

FIG. 2 is a flow diagram illustrating one configuration of a method 200 for coordinating dynamic communication periods on a wireless communication device 102. The method 200 is illustrated as beginning from step 202. However, it should be noted that the method 200 may begin at any step illustrated in accordance with the systems and methods disclosed herein.

A wireless communication device 102 may receive 202 signals from and/or transmit 202 signals to an Access Point (AP) 190 during an STA awake state (and/or during a UE unscheduled period (UUP), for example). For example, the STA 136 may receive 202 one or more frames from the AP 190 and/or may transmit 202 one or more frames to the AP 190. During the STA awake state, for instance, the STA 136 may receive one or more beacon frames, Acknowledgement (ACK) frames and/or data frames. Furthermore, the STA 136 may transmit one or more PS-Poll frames, ACK frames and/or data frames to the AP 190. It should be noted that the STA awake state may also be referred to as an awake period, Wi-Fi active period or a Wi-Fi awake period herein.

During the STA awake state (e.g., while the UUP timer 134 is running), the wireless communication device 102 may not monitor a PDCCH from the eNB 160. In this case, the wireless communication device 102 may not transmit hybrid automatic repeat request (HARQ) feedback, a sounding reference signal (SRS), a channel quality indicator (CQI) a precoding matrix indicator (PMI) or a rank indicator (RI), other than a possible Scheduling Request (SR), to the eNB 160.

The wireless communication device 102 may determine 204 whether the STA's 136 awake state has ended. This determination 204 may be based on one or more triggers. For example, if the UE unscheduled period (UUP) timer 134 has expired or stopped, the wireless communication device 102 may determine 204 that the STA's 136 awake state has ended. Additionally or alternatively, if the STA 136 currently has no more data 138 (as indicated by a TIM, for example) to receive from the AP 190 and has no more data 146 to transmit to the AP 190, the wireless communication device 102 may determine 204 that the STA's 136 awake state has ended. Additionally or alternatively, if the UE 104 sends a Scheduling Request (SR), the wireless communication device 102 may determine 204 that the STA's 136 awake state has ended. This may occur, for example, if the UE 104 needs to communicate with the eNB 160 (to send a UE scheduled period MAC CE, for instance). If the wireless communication device 102 sends a Scheduling Request (SR), for instance, the wireless communication device 102 may stop the UUP timer 134. If the wireless communication device 102 determines 204 that the STA's 136 awake state has not ended, it 102 may continue to receive 202 signals from and/or transmit 202 signals to the AP 190. It should be noted that in some cases, the end of the STA 136 awake period may correspond to the end of the UE unscheduled period (UUP).

If the wireless communication device 102 determines 204 that the STA's 136 awake state has ended, it 102 may determine 206 a Wi-Fi sleep period (WSP) value 132. In one configuration, the wireless communication device 102 may make this determination 206 based on a STA 136 Quality of Service (QoS). For example, if the STA 136 is using a QoS that requires a particular bit rate, the wireless communication device 102 may determine a Wi-Fi sleep period (WSP) value 132 that will not disrupt the QoS (e.g., a higher QoS may require a shorter WSP). For instance, the coordination controller 128 may determine the WSP value 132 using QoS information that is provided via SMA 159 interfaces.

It should be noted that if the wireless communication device 102 determines 204 that the STA's 136 awake state has ended, the wireless communication device 102 may stop the UE unscheduled period (UUP) timer 134 if it 134 has not been already stopped (e.g., if it 134 expired or reached a limit).

The wireless communication device 102 may determine 208 a UE scheduled period (USP) value 130. In one configuration, the UE scheduled period (USP) value 130 may be determined 208 based on the Wi-Fi sleep period (WSP). For example, the UE scheduled period (USP) value 130 may be the same as the Wi-Fi sleep period (WSP) value 132. In another example, the UE scheduled period (USP) value 130 may be determined such that the Wi-Fi sleep period (WSP) will end at (roughly) the same time as the UE scheduled period (USP).

The wireless communication device 102 may start 210 a Wi-Fi sleep period. For example, the wireless communication device 102 may instruct the STA 136 to enter into a doze state. This may cause the STA 136 to stop sending communications (e.g., frames) to the AP 190 and to stop receiving communications (e.g., frames) from the AP 190.

The wireless communication device 102 may receive 212 signals from the eNB 160 and/or transmit signals to the eNB 160 during a UE scheduled period (USP). For example, the UE 104 may begin or continue typical procedures for communicating with the eNB 160. For instance, the wireless communication device 102 (e.g., UE 104) may monitor a PDCCH for control information. The wireless communication device 102 (e.g., UE 104) may additionally transmit control information and/or payload data 114 to the eNB 160.

The wireless communication device 102 (e.g., UE 104) may send 214 a UE scheduled period (USP) medium access control (MAC) control element (CE). For example, the wireless communication device 102 may generate a USP MAC CE based on the UE scheduled period (USP) value 130. The wireless communication device 102 (e.g., UE 104) may then transmit the USP MAC CE to the eNB 160. In some cases, the wireless communication device 102 may send a Scheduling Request (SR) to the eNB 160 in order to send 214 the USP MAC CE.

The wireless communication device 102 may determine 216 whether a Wi-Fi sleep period (WSP) has ended. This determination 216 may be based on one or more events. For example, the wireless communication device 102 may detect that an amount of time equal to the Wi-Fi sleep period value 132 has occurred, indicating that the Wi-Fi sleep period (WSP) has ended. In one configuration, this may be detected using information provided by the SME 159.

Additionally or alternatively, the receipt of a UE unscheduled period (UUP) medium access control (MAC) control element (CE) by the wireless communication device 102 (from the eNB 160) may indicate that the Wi-Fi sleep period (WSP) has ended. Additionally or alternatively, the start of the UE unscheduled period (UUP) timer 134 may indicate that the Wi-Fi sleep period (WSP) has ended.

It should be noted that if the determination 216 is based on some event other than the UE unscheduled period (UUP) timer 134 being started, the wireless communication device 102 may start the UUP timer 134 if it 102 has determined 216 that the Wi-Fi sleep period has ended. For instance, if the wireless communication device 102 receives the UUP MAC CE from the eNB 160, the wireless communication device 102 may initialize the UE unscheduled period (UUP) timer 134 limit to a value (e.g., UUP_Max) and start or restart the UUP timer 134. It should be noted that the value (e.g., UUP_Max) may be provided to the wireless communication device 102 by the UUP MAC CE. Otherwise, the value (e.g., UUP_Max) may be semi-statically configured in the wireless communication device 102.

In one configuration, different components (e.g., the UE 104 and the STA 136) of the wireless communication device 102 may make separate determinations (to determine 216 that the Wi-Fi sleep period (WSP) has ended) based on different events. For example, the UE 104 may determine that the Wi-Fi sleep period has ended based on the receipt of the UE unscheduled period (UUP) MAC CE. In response to the receipt of the UUP MAC CE, the wireless communication device 102 may start the UUP timer 134. The STA 136 may then determine that the Wi-Fi sleep period (WSP) has ended based on the start of the UUP timer 134.

If the wireless communication device 102 determines 216 that the Wi-Fi sleep period (WSP) has not ended, the wireless communication device 102 may return to determine 216 whether the Wi-Fi sleep period (WSP) has ended. For example, the wireless communication device 102 may continue to operate in its current state (e.g., receiving 212 signals from and/or transmitting 212 signals to the eNB 160) and eventually return to determine 216 whether the Wi-Fi sleep period (WSP) has ended. For instance, while the UUP timer 134 is not running, the wireless communication device 102 may follow the normal procedures including discontinuous reception (DRX) procedures and monitor a PDCCH for DL assignments and UL grants. In discontinuous reception (DRX) procedures, the UE 104 may be required to monitor a PDCCH in active time and may not be required to monitor a PDCCH in inactive time.

If the wireless communication device 102 determines 216 that the Wi-Fi sleep period (WSP) has ended, it 102 may start 218 a UE unscheduled period. For example, the wireless communication device 102 may instruct the UE 104 to discontinue communications with the eNB 160. For instance, the UE 104 may stop or avoid receiving any signals from the eNB 160 and stop or avoid transmitting any signals to the eNB 160. The wireless communication device 102 may also instruct the STA 136 to exit a doze state. This may cause the wireless communication device 102 to receive 202 signals from and/or transmit 202 signals to an Access Point (AP) 190 during a UE unscheduled period (UUP). In other words, when exiting the Wi-Fi sleep period (WSP), the STA 136 may receive communications (e.g., frames) from the AP 190 and/or may transmit communications (e.g., frames) to the AP 190.

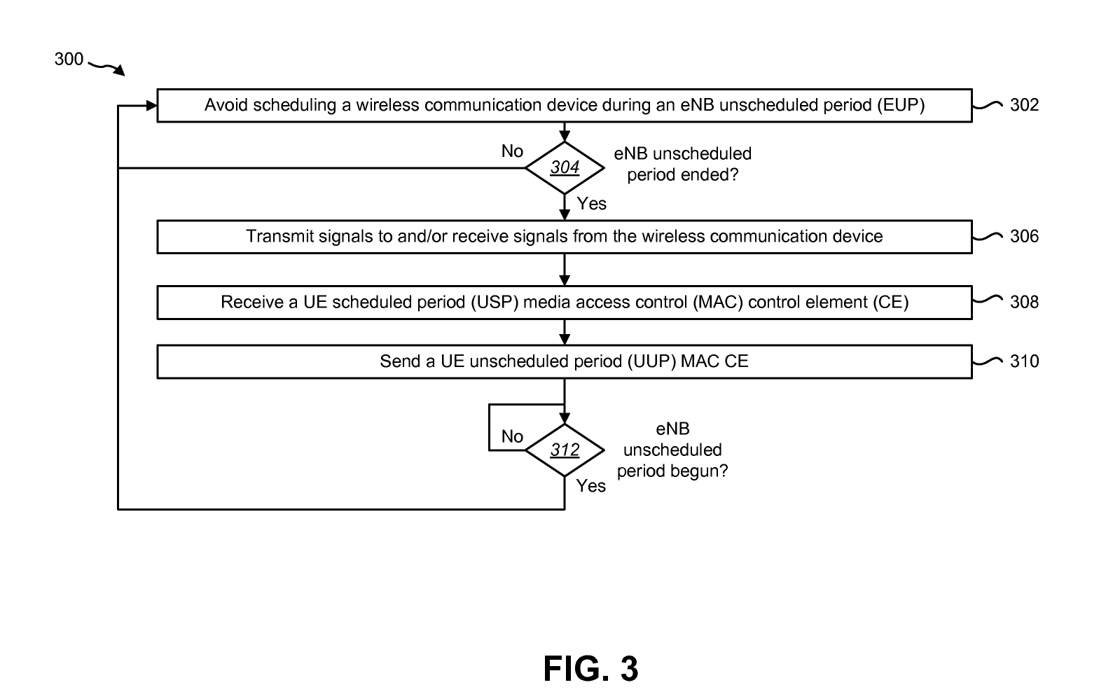

FIG. 3 is a flow diagram illustrating one configuration of a method 300 for controlling dynamic communication periods on an enhanced or evolved Node B (eNB) 160. The eNB 160 may avoid scheduling 302 a wireless communication device 102 (e.g., UE 104) during an eNB unscheduled period (EUP). For example, the eNB 160 may prevent or avoid transmitting signals specific to the wireless communication device 102 (e.g., PDCCHs, etc.) during the eNB unscheduled period (EUP). In particular, the eNB 160 may not schedule 302 any protocol resources for the wireless communication device 102 during the eNB unscheduled period (EUP). Additionally, the eNB 160 may prevent or avoid receiving signals from the wireless communication device 102 (except for a possible Scheduling Request (SR)) during the eNB unscheduled period (EUP).

The eNB 160 may determine 304 whether the eNB unscheduled period (EUP) has ended. This determination 304 may be based on one or more events. For example, the eNB 160 may receive a Scheduling Request (SR) from the wireless communication device 102 (for a UE scheduled period MAC CE, for example), which may indicate that the eNB unscheduled period (EUP) has ended. If the eNB 160 detects a Scheduling Request (SR) from the wireless communication device 102, the eNB 160 may stop the EUP timer 180.

Additionally or alternatively, the end of the eNB unscheduled period (EUP) may be indicated by the expiration of the eNB unscheduled period (EUP) timer 180. If the eNB 160 determines 304 that the eNB unscheduled period (EUP) has ended, the eNB 160 may stop the EUP timer 180 if it has not stopped (e.g., expired) already. If the eNB 160 determines 304 that the eNB unscheduled period (EUP) has not ended, the eNB 160 may continue to avoid 302 scheduling the wireless communication device 102 during the eNB unscheduled period.

If the eNB 160 determines 304 that the eNB unscheduled period has ended, the eNB 160 may transmit 306 signals to and/or receive 306 signals from the wireless communication device 102. For example, the eNB 160 may start or continue normal scheduling procedures. This may allow the eNB 160 and the wireless communication device 102 (e.g., UE 104) to transmit signals to and/or receive signals from each other. For instance, while the EUP timer 180 is not running, the eNB 160 may follow normal scheduling procedures, including normal discontinuous reception (DRX) procedures to schedule DL and/or UL communications with the wireless communication device 102 (e.g., UE 104). It should be noted that the UE unscheduled period (UUP) and eNB unscheduled period may be synchronized, though misalignment may happen in an error case.

The eNB 160 may receive 308 a UE scheduled period (USP) MAC CE. The eNB 160 may start (or restart) the UE scheduled period (USP) timer 182. For example, if the eNB 160 receives 308 the USP MAC CE with a valid UE scheduled period (USP) value, the eNB 160 may initialize the USP timer 182 limit to a UE scheduled period (USP) value 178 indicated by the USP MAC CE. Furthermore, the eNB 160 may start or restart the USP timer 182.

The eNB 160 may send 310 a UE unscheduled period (UUP) MAC CE to the wireless communication device 102. This may occur at some time before the UE scheduled period (USP) timer 182 expires. For example, the eNB 160 may send 310 a UUP MAC CE at any time the eNB 160 wants the wireless communication device 102 to go to the UE unscheduled period (UUP). The eNB 160 may include a timer limit value (e.g., UUP_MAX) in the UUP MAC CE.

The eNB 160 may determine 312 whether an (e.g., another) eNB unscheduled period (EUP) has begun. This determination 312 may be based on one or more events. For example, the eNB 160 may determine 312 that the eNB unscheduled period has begun if the UE scheduled period (USP) timer 182 has expired. For instance, if the USP timer 182 expires, the eNB 160 may assume that the wireless communication device 102 (e.g., STA 136) may finish being in a Wi-Fi Sleep Period (WSP), which means there is a high possibility of an IDC interference problem (if the eNB 160 continues to communicate with the wireless communication device 102, for example).

The beginning of the eNB unscheduled period (EUP) may be indicated if the eNB 160 sends 312 a UUP MAC CE. In this case, the eNB 160 may initialize the EUP timer 180 limit to a timer limit value (e.g., EUP_Max). The eNB 160 may also start or restart the EUP timer 180.

If the eNB 160 determines 312 that the eNB unscheduled period (EUP) has not begun, the eNB 160 may return to determining 312 whether the eNB unscheduled period has begun (at a later time). For example, the eNB 160 may continue transmitting 306 signals to and/or receiving 306 signals from the wireless communication device 102.

If the eNB 160 determines 312 that the eNB unscheduled period (EUP) has begun, the eNB may start the eNB unscheduled period (UUP) timer 180. During the eNB unscheduled period (EUP), the eNB 160 may avoid scheduling 302 the wireless communication device 102. For example, while the EUP timer 180 is running, the eNB 160 may not schedule protocol resources for the wireless communication device 102 (e.g., UE). This may be done by not transmitting any PDCCH for DL assignments or UL grants, for instance. The eNB 160 may also not receive hybrid automatic repeat request (HARQ) feedback, a sounding reference signal (SRS), a channel quality indicator (CQI) a precoding matrix indicator (PMI) or a rank indicator (RI), other than a Scheduling Request (SR) from the wireless communication device 102 (e.g., UE).

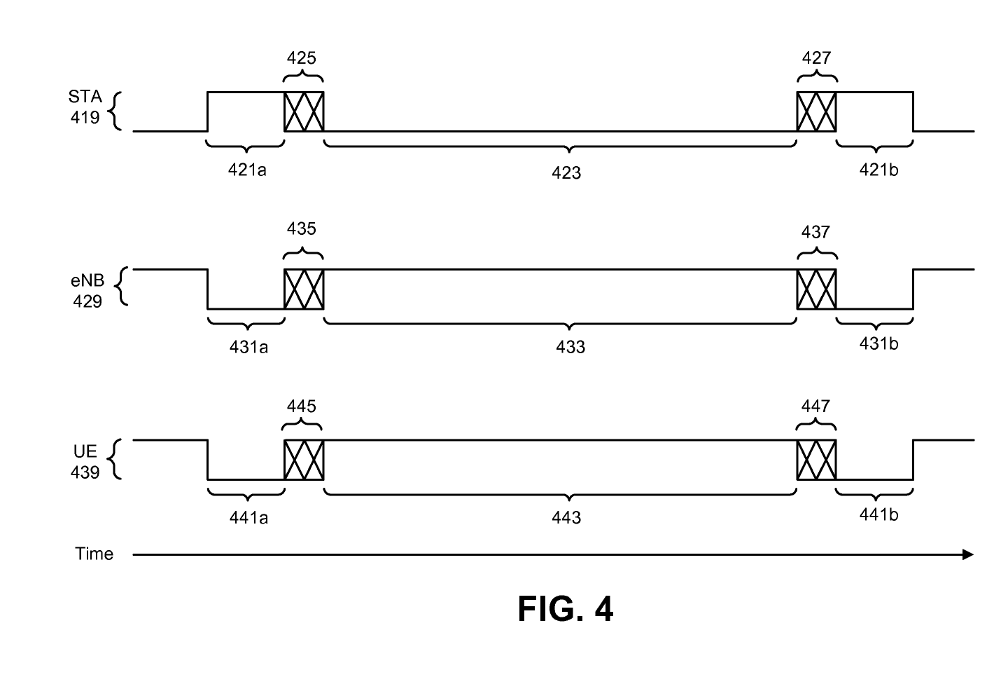

FIG. 4 is a diagram illustrating one example of coordinating dynamic communication periods. In this example, communication periods for a STA 419, and eNB 429 and a UE 439 are illustrated. It should be noted that the STA 419 and the UE 439 may be co-located in the same device (e.g., wireless communication device 102). As illustrated, the communication periods may vary over time, which is illustrated on a horizontal axis.

For the STA 419, two awake or active periods 421a-b and a Wi-Fi sleep period (e.g., WSP or doze period) 423 are illustrated. A transition 425 from the first awake period 421a to the Wi-Fi sleep period 423 is illustrated. Also, a transition 427 from the Wi-Fi sleep period 423 to the second awake period 421b is illustrated.

For the eNB 429, two eNB unscheduled periods (EUPs) 431a-b and an eNB scheduled period and/or UE scheduled period (USP) 433 are illustrated. A transition 435 from the first EUP 431a to the USP 433 is illustrated. Also, a transition 437 from the USP 433 to the second EUP 431b is illustrated.

For the UE 439, two UE unscheduled periods (UUPs) 441a-b and a UE scheduled period (USP) 443 are illustrated. A transition 445 from the first UUP 441a to the USP 443 is illustrated. Also, a transition 447 from the USP 443 to the second EUP 441b is illustrated.

During the first period 421a, 431a, 441a, the STA 419 is actively communicating with an AP and the eNB 429 and UE 439 are not communicating with each other. In the first transition 425 for the STA 419, a wireless communication device that includes the STA 419 and the UE 439 may detect that the STA 419 has no more data to transmit to and/or to receive from an AP or a UE unscheduled period (UUP) timer may have expired. At this point, the wireless communication device may cause the STA 419 to enter the Wi-Fi sleep period (WSP) 423. Thus, the STA 419 may discontinue receiving signals from and/or transmitting signals to the AP during the Wi-Fi sleep period 423.

In the first transition 445 for the UE 439, the UE 439 may send a Scheduling Request (SR) for sending a UE scheduled period (USP) MAC CE, or the UE unscheduled period (UUP) timer may have expired. At this point, the wireless communication device may stop the UUP timer. The UE 439 may start or continue normal communication procedures for communicating with the eNB 429. The UE 439 may send a UE scheduled period (USP) MAC CE.

In the first transition 435 for the eNB 429, the eNB 429 may detect a Scheduling Request (SR) or an eNB unscheduled period (EUP) timer may expire. At this point, the eNB 429 may stop the EUP timer. The eNB 429 may also start or continue normal scheduling procedures for communicating with the UE 439. The eNB 429 may also receive a USP MAC CE from the UE and may start a UE scheduled period (USP) timer.

After the first transition 425, 435, 445, the STA 419 is not actively communicating with an AP. However, the eNB 429 and the UE 439 are actively communicating with each other. This second period 423, 433, 443 may continue until the second transition 427, 437, 447. At the second transition 437 for the eNB 429 (and at some time before a UE scheduled period (USP) timer expires), the eNB 429 may send a UE unscheduled period (UUP) MAC CE to the UE 439. During this transition 437, the eNB 429 may start the eNB unscheduled period (EUP) timer. In the third period 431b (e.g., eNB unscheduled period (EUP)) for the eNB 429, the eNB may not schedule protocol resources for the UE 439 and may not receive anything from the UE 439, except for a possible Scheduling Request (SR).

In the second transition 447 for the UE 439, the UE 439 may receive the UE unscheduled period (UUP) MAC CE from the eNB 429. At this point, the UE 439 may start the UE unscheduled period (UUP) timer. In the third period 441b (e.g., UE unscheduled period (UUP)) for the UE 439, the UE 439 may not monitor for a PDCCH and may not transmit anything to the eNB 429 except for a possible Scheduling Request (SR).

In the second transition 427 for the STA 419, the wireless communication device may detect that the Wi-Fi sleep period (e.g., WSP or doze period) has finished or that the UE unscheduled period (UUP) timer has started. The wireless communication device may cause the STA 419 to exit the Wi-Fi sleep period (WSP). In the third period 421b (e.g., while in an awake state) for the STA 419, the STA 419 may communicate with (e.g., receive signals from and/or transmit signals to) the AP.

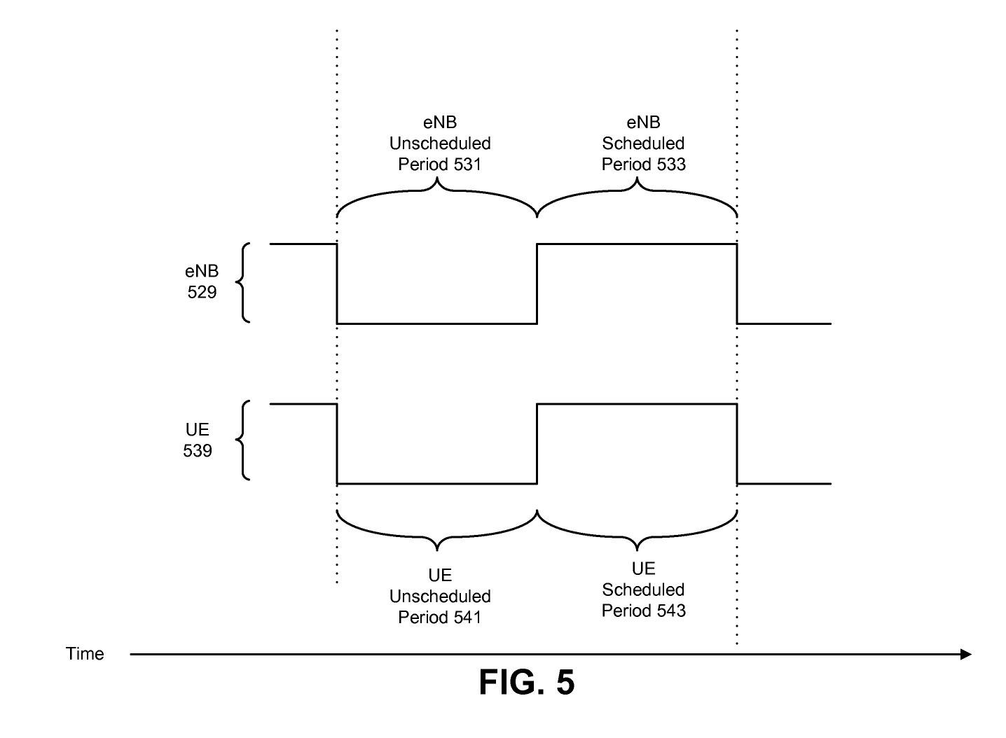

FIG. 5 is a diagram illustrating another example of coordinating dynamic communication periods for an enhanced or evolved Node B (eNB) 529 and a User Equipment (UE) 539. In this example, communication periods for an eNB 529 and a UE 539 are illustrated. It should be noted that the UE 539 may be co-located with a STA in the same device (e.g., wireless communication device 102). As illustrated, the communication periods may vary over time, which is illustrated on a horizontal axis.

For the eNB 529, an eNB unscheduled period (EUP) 531 and an eNB scheduled period 533 are illustrated. For the UE 539, a UE unscheduled period (UUP) 541 and a UE scheduled period (USP) 543 are illustrated.

During the first period 531, 541 the eNB 529 and UE 539 are not communicating with each other. For example, the UE 539 will not transmit any signals to the eNB 529, except for a possible Scheduling Request (SR), during the UE unscheduled period (UUP) 541. Furthermore, the UE 539 may not receive any signals from the eNB 529 during the UUP 541. For instance, the UE 539 may not monitor for a PDCCH during the UUP 541.

The eNB 529 may also not receive any signals from the UE 539, except for a possible Scheduling Request (SR), during the eNB unscheduled period (EUP) 531. Additionally, the eNB 529 may not transmit any signals to the UE 539 during the EUP 531. For instance, the eNB 529 may not send a PDCCH to the UE 539 during the EUP 531.

When transitioning from the first period 531, 541 to the second period 533, 543, a wireless communication device that includes a STA and the UE 539 may detect that the STA has no more data to transmit to and/or to receive from an AP or may detect that a UE unscheduled period (UUP) timer may have expired. In this transition, the UE 539 may send a Scheduling Request (SR) for sending a UE scheduled period (USP) MAC CE, or the unscheduled period (UUP) timer may have expired. At this point, the wireless communication device may stop the UUP timer. The UE 539 may start or continue normal communication procedures for communicating with the eNB 529. The UE 539 may send a UE scheduled period (USP) MAC CE.

When transitioning from the first period 531, 541 to the second period 533, 543, the eNB 529 may detect a Scheduling Request (SR) or an eNB unscheduled period (EUP) timer may expire. At this point, the eNB 529 may stop the EUP timer. The eNB 529 may also start or continue normal scheduling procedures for communicating with the UE 539. The eNB 529 may also receive a USP MAC CE from the UE and may start a UE scheduled period (USP) timer.

After transitioning from the first period 531, 541 to the second period 533, 543 the eNB 529 and the UE 539 may actively communicate with each other. During the eNB scheduled period 533, for example, the eNB 529 may perform normal uplink (UL) and downlink (DL) scheduling of network resources. During the UE scheduled period (USP) 543, for example, the UE 539 may perform normal transmission and reception activity. For instance, discontinuous reception (DRX) may be scheduled by the eNB 529 during the USP 543.

This second period 533, 543 may continue until the eNB 529 transitions to another eNB unscheduled period and until the UE 539 transitions to another UE unscheduled period. At some time before a UE scheduled period (USP) timer expires, the eNB 529 may send a UE unscheduled period (UUP) MAC CE to the UE 539. During this transition, the eNB 529 may start the eNB unscheduled period (EUP) timer. In transitioning to another UE unscheduled period, the UE 539 may receive the UE unscheduled period (UUP) MAC CE from the eNB 529. At this point, the UE 539 may start a UE unscheduled period (UUP) timer. In transitioning to another UE unscheduled period, a wireless communication device that includes the UE 539 may detect that a Wi-Fi sleep period (e.g., WSP or doze period) has finished and/or that the UE unscheduled period (UUP) timer has started.

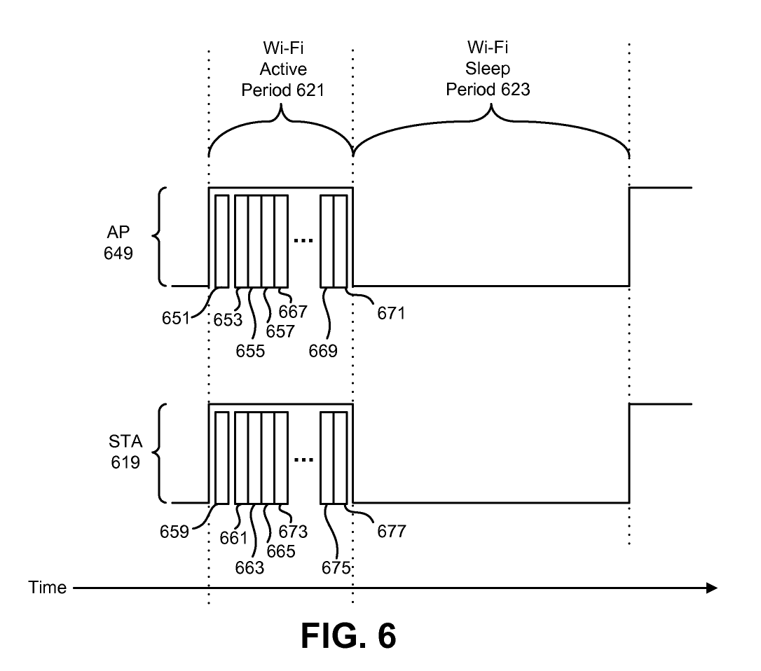

FIG. 6 is a diagram illustrating another example of coordinating dynamic communication periods for a Station (STA) 619. In this example, communication periods for an AP 649 and a STA 619 are illustrated. It should be noted that the STA 619 may be co-located with a UE in the same device (e.g., wireless communication device 102). As illustrated, the communication periods may vary over time, which is illustrated on a horizontal axis.

For the STA 619 and the AP 649, a Wi-Fi active (e.g., awake) period 621 and a Wi-Fi sleep period (e.g., WSP or doze period) 623 are illustrated. During the Wi-Fi active period 621, the AP 649 and the STA 619 may communicate with each other.

In the example illustrated in FIG. 6, examples of several communication frames are shown. For instance, the AP 649 may transmit a beacon 651 to the STA 619. The beacon 651 may include a traffic indication map (TIM), which may specify to the STA 619 whether the AP 649 has buffered traffic (e.g., data) destined for the STA 619. The STA 619 may receive the beacon 659.

The STA 619 may send a power save poll (PS-Poll) 661, indicating that the STA 619 is ready to receive a data frame (if the AP 649 indicates that it has buffered data for the STA 619, for example). The AP 649 may receive the PS-Poll 653 and may respond by sending an Acknowledgement (ACK) 655 and a data frame 657. The STA 619 may receive the ACK 663 and the data frame 665. The STA 619 may then respond by sending an ACK 673. The AP 649 may receive the ACK 667.

Additionally, the STA 619 may send a data frame 675 to the AP 649. The AP 649 may receive the data frame 669 and may respond by sending an ACK 671. The STA 619 may receive the ACK 677. During the Wi-Fi active period 621, operation may similarly continue. For example, the AP 649 may send one or more beacons, one or more ACKs and/or one or more data frames to the STA 619. Additionally or alternatively, the STA 619 may send one or more PS-Polls, one or more ACKs and/or one or more data frames to the AP 649.

When transitioning from the Wi-Fi active period 621 to the Wi-Fi sleep period (WSP) 623, a wireless communication device that includes the STA 619 and a UE may detect that the STA 619 has no more data to transmit to and/or to receive from an AP 649 or may detect that a UE unscheduled period (UUP) timer has expired. Additionally or alternatively, the UE may send a Scheduling Request (SR). At this point, the wireless communication device may cause the STA 619 to enter the Wi-Fi sleep period (WSP) 623. Thus, the STA 619 may discontinue receiving signals from and/or transmitting signals to the AP 649 during the Wi-Fi sleep period 623. During the Wi-Fi sleep period 623, the AP 649 may be considered to be in monitor mode.

When transitioning from the Wi-Fi sleep period 623 to another Wi-Fi active period, the wireless communication device may detect that the Wi-Fi sleep period (e.g., WSP or doze period) 623 has finished and/or that the UE unscheduled period (UUP) timer has started. Additionally or alternatively, the wireless communication device may receive an unscheduled period (UUP) MAC CE for this transition. The wireless communication device may cause the STA 619 to exit the Wi-Fi sleep period (WSP) 623. The STA 619 may communicate with (e.g., receive signals from and/or transmit signals to) the AP 649.

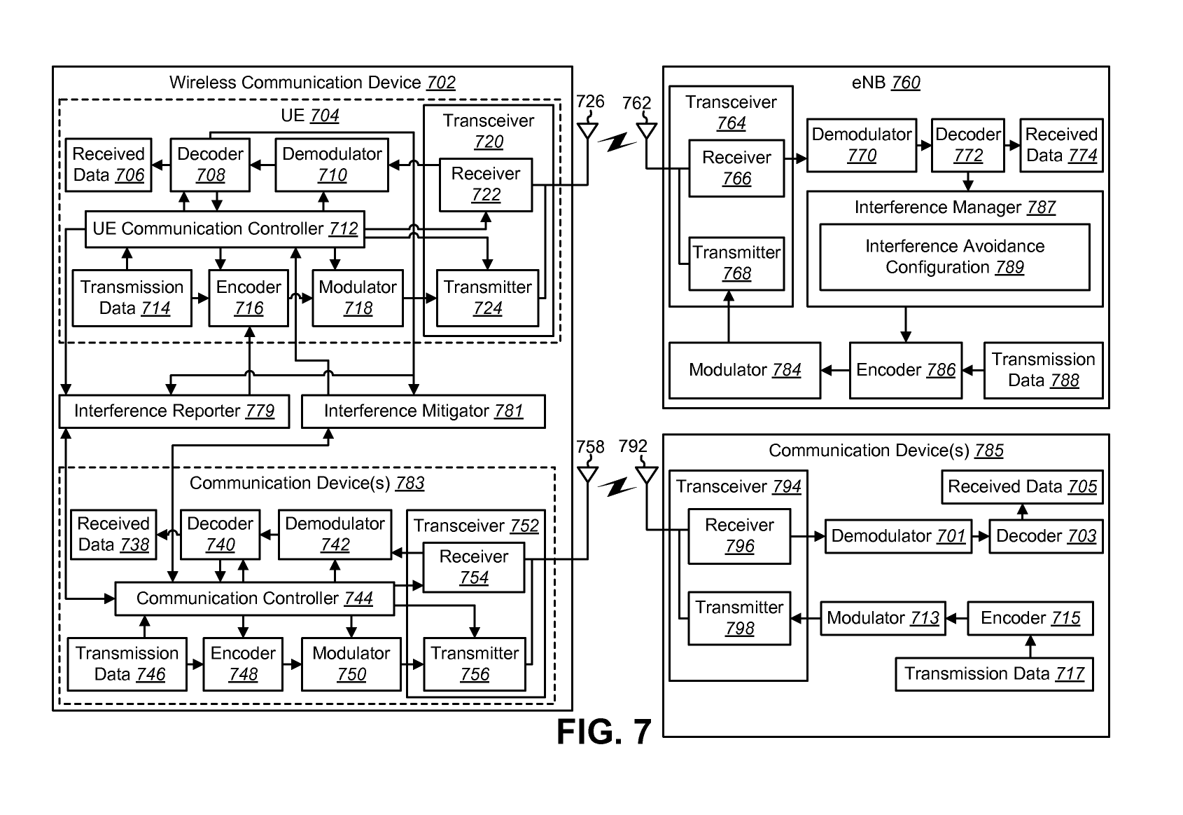

FIG. 7 is a block diagram illustrating one configuration of a wireless communication device 702 and an enhanced or evolved Node B (eNB) 760 in which systems and methods for controlling interference may be implemented. The wireless communication device 702 communicates with an enhanced or evolved Node B (eNB) 760 using one or more antennas 726. For example, the wireless communication device 702 transmits electromagnetic signals to the eNB 760 and receives electromagnetic signals from the eNB 760 using the one or more antennas 726. The eNB 760 communicates with the wireless communication device 702 using one or more antennas 762. It should be noted that the eNB 760 may be a Node B, an enhanced or evolved Node B, a home enhanced or evolved Node B (HeNB) or other kind of base station in some configurations.

The wireless communication device 702 and the eNB 760 may use one or more channels to communicate with each other. For example, the wireless communication device 702 and eNB 760 may use one or more channels (e.g., Physical Uplink Control Channel (PUCCH), Physical Uplink Shared Channel (PUSCH), Physical Random Access Channel (PRACH), Uplink Shared Channel (UL-SCH), Downlink Shared Channel (DL-SCH), Physical Downlink Control Channel (PDCCH), etc.).

The wireless communication device 702 may include a User Equipment (UE) 704, an interference reporter 779, an interference mitigator 781 and one or more communication devices 783. Examples of the one or more communication devices 783 include Bluetooth communication devices, IEEE 802.11 (e.g., “Wi-Fi”) devices and other devices that operate in the ISM band. The UE 704 may include one or more elements or components used to communicate with the eNB 760. For example, the UE 704 may include one or more transceivers 720, one or more demodulators 710, one or more decoders 708, one or more encoders 716, one or more modulators 718 and a UE communication controller 712. For instance, one or more reception and/or transmission paths may be used in the UE 704. For convenience, only a single transceiver 720, decoder 708, demodulator 710, encoder 716 and modulator 718 are illustrated, though multiple parallel elements 720, 708, 710, 716, 718 may be used depending on the configuration.

The UE transceiver 720 may include one or more receivers 722 and one or more transmitters 724. The one or more receivers 722 may receive signals from the eNB 760 using one or more antennas 726. For example, the receiver 722 may receive and downconvert signals to produce one or more received signals. The one or more received signals may be provided to a demodulator 710. The one or more transmitters 724 may transmit signals to the eNB 760 using one or more antennas 726. For example, the one or more transmitters 724 may upconvert and transmit one or more modulated signals.

The demodulator 710 may demodulate the one or more received signals to produce one or more demodulated signals. The one or more demodulated signals may be provided to the decoder 708. The wireless communication device 702 may use the decoder 708 to decode signals. The decoder 708 may produce one or more decoded signals. For example, a first UE-decoded signal may comprise received payload data 706. A second UE-decoded signal that is provided to the UE communication controller 712 may include control (e.g., scheduling) information. For example, the second UE-decoded signal may include data that is received on a Physical Downlink Control Channel (PDCCH). Other UE-decoded signals that are provided to the interference reporter 779 and the interference mitigator 781 may comprise overhead data and/or control data. For example, one decoded signal that is provided to the interference reporter 779 may include a command to enable or disable interference reporting by the wireless communication device 702. Another decoded signal that is provided to the interference mitigator 781 may include a command to enable or disable interference mitigation procedures.

The UE communication controller 712 may be used to control communication functions within the UE 704. For example, the UE communication controller 712 may control the decoder 708, the demodulator 710, the receiver 722, the transmitter 724, the modulator 718 and the encoder 716. For instance, the UE communication controller 712 may send one or more signals to the decoder 708, the demodulator 710, the receiver 722, the transmitter 724, the modulator 718 and the encoder 716. This may allow the UE communication controller 712 to schedule data transmission and/or reception, for instance. In some configurations, the UE communication controller 712 may control the encoder 716, modulator 718 and/or transmitter 724 based on the amounts and/or type of transmission data 714.

The UE communication controller 712 may provide information to the receiver 722, demodulator 710 and/or decoder 708. This information may include instructions. For example, the UE communication controller 712 may instruct the receiver 722, demodulator 710 and/or decoder 708 to suspend operation in order to avoid interfering with the one or more communication devices 783.

The encoder 716 may encode transmission data 714, information provided by the UE communication controller 712 and information provided by the interference reporter 779. For example, encoding the data 714 and/or other information may involve error detection and/or correction coding, mapping data to space, time and/or frequency resources (e.g., space-time block coding (STBC)) for transmission, etc. The UE communication controller 712 may provide scheduling information to the encoder 716, such as a Scheduling Request (SR), for example. The interference reporter 779 may provide information to the encoder 716, such as an interference report that may include information such as the detection of interference caused by UE 704 uplink transmissions on downlink reception for the one or more communication devices 783 and/or detection of interference caused by uplink transmissions by the communication device(s) 783 on the downlink reception for the UE 704. The encoder 716 may provide encoded data to the modulator 718.

The UE communication controller 712 may provide information to the modulator 718. This information may include instructions for the modulator 718. For example, the UE communication controller 712 may instruct the modulator 718 to suspend operation to avoid interfering with communication device 783 communications. The modulator 718 may modulate the encoded data to provide one or more modulated signals to the one or more transmitters 724.

The UE communication controller 712 may provide information to the one or more transmitters 724. This information may include instructions for the one or more transmitters 724. For example, the UE communication controller 712 may instruct the one or more transmitters 724 to suspend operation to avoid interfering with communication device 783 communications. The one or more transmitters 724 may upconvert and transmit the modulated signal(s) to the eNB 760.

The communication device(s) 783 may include one or more elements or components used to communicate with one or more other communication devices 785. For example, each of the communication device(s) 783 may include one or more transceivers 752, one or more demodulators 742, one or more decoders 740, one or more encoders 748, one or more modulators 750 and a communication controller 744. For instance, one or more reception and/or transmission paths may be used in the communication device(s) 783. For convenience, only a single transceiver 752, decoder 740, demodulator 742, encoder 748 and modulator 750 are illustrated, though multiple parallel elements 752, 740, 742, 748, 750 may be used depending on the configuration. In one configuration, the communication device(s) 783 may transmit and/or receive signals in the Industrial, Scientific and Medical (ISM) frequency band. Examples of the communication device(s) 783 include IEEE 802.11 (e.g., Wi-Fi) devices, Bluetooth devices, etc.

In some configurations, one or more of the communication devices 783 may include a Station Management Entity (SME). For example, a STA may provide an SME to communicate with other elements, components or entities on the wireless communication device 702. In this case, the SME may provide an interface through which one or more of the signals, commands, messages, pieces of information, etc., described herein that pass between the interference reporter 779 and the communication device(s) 783 and/or that pass between the interference mitigator 781 and the communication device(s) 783 may be handled by the SME. This may be in addition to or alternatively from communications handled by any other element or component of the communication device(s) 783.

The transceiver 752 may include one or more receivers 754 and one or more transmitters 756. The one or more receivers 754 may receive signals from one or more communication devices 785 using one or more antennas 758. For example, the receiver 754 may receive and downconvert signals to produce one or more received signals. The one or more received signals may be provided to a demodulator 742. The one or more transmitters 756 may transmit signals to the communication device(s) 785 using one or more antennas 758. For example, the one or more transmitters 756 may upconvert and transmit one or more modulated signals.

The demodulator 742 may demodulate the one or more received signals to produce one or more demodulated signals. The one or more demodulated signals may be provided to the decoder 740. The communication device(s) 702 may use the decoder 740 to decode signals. The decoder 740 may produce one or more decoded signals. For example, a first decoded signal may comprise received payload data 738. A second decoded signal may provide data to the communication controller 744 that the communication controller 744 may use to perform one or more operations, such as transmission and/or reception scheduling.

The communication controller 744 may be used to manage communications between the communication device(s) 783 on the wireless communication device 702 and the one or more communication device(s) 785. For example, the communication controller 744 may control the decoder 740, the demodulator 742, the receiver 754, the transmitter 756, the modulator 750 and the encoder 748. For instance, the communication controller 744 may send one or more signals to the decoder 740, the demodulator 742, the receiver 754, the transmitter 756, the modulator 750 and the encoder 748. This may allow the communication controller 744 to control data transmission and/or reception, for instance. In some configurations, the communication controller 744 may control the encoder 748, modulator 750 and/or transmitter 756 based on the amounts and/or type of transmission data 746.

The communication controller 744 may provide information to the receiver 754, demodulator 742 and/or decoder 740. This information may include instructions. For example, the communication controller 744 may instruct the receiver 754, demodulator 742 and/or decoder 740 to reduce or suspend operation to avoid interfering with UE 704 communications.

The encoder 748 may encode transmission data 746 and/or other information provided by the communication controller 744. For example, encoding the data 746 and/or other information may involve error detection and/or correction coding, mapping data to space, time and/or frequency resources (e.g., space-time block coding (STBC)) for transmission, etc. For instance, the communication controller 744 may provide scheduling information to the encoder 748 for transmission to the one or more communication devices 785. The encoder 748 may provide encoded data to the modulator 750.

The communication controller 744 may provide information to the modulator 750. This information may include instructions for the modulator 750. For example, the communication controller 744 may instruct the modulator 750 to suspend operation to avoid interfering with UE 704 communications. The modulator 750 may modulate the encoded data to provide one or more modulated signals to the one or more transmitters 756.

The communication controller 744 may provide information to the one or more transmitters 756. This information may include instructions for the one or more transmitters 756. For example, the communication controller 744 may instruct the one or more transmitters 756 to suspend to avoid interfering with UE 704 communications. The one or more transmitters 756 may upconvert and transmit the modulated signal(s) to the communication device(s) 785.

It should be noted that each of the elements or components included in the wireless communication device 702 may be implemented in hardware, software or a combination of both. For example, the interference reporter 779 and the interference mitigator 781 may be implemented in hardware, software or a combination of both.

The interference reporter 779 may generate one or more reports regarding interference between the UE 704 and the one or more communication devices 783 that are co-located on the wireless communication device 702. For example, the wireless communication device 702 may receive an enable interference reporting command from the eNB 760. The interference reporter 779 may then generate a report regarding interference that may be sent to the eNB 760. The wireless communication device 702 may also receive a disable interference reporting command from the eNB 760. In this case, the interference reporter 779 may stop interference reporting.

The interference mitigator 781 may control the UE 704 and the one or more communication devices 783 that are co-located on the wireless communication device 702 in order to reduce interference. For example, the wireless communication device 702 may receive an implicit or explicit command to use UE autonomous denial (UAD), which may be sent in a start interference mitigation message or in a separate message from the eNB 760. The start interference mitigation message may include an interference avoidance configuration, which is a data set that specifies how the interference mitigator 781 may reduce interference. The interference mitigator 781 may then mitigate interference using UAD (and/or according to the interference avoidance configuration, for example). The wireless communication device 702 may also receive a command to stop using UAD that may be sent in a stop interference mitigation message or in a separate message from the eNB 760. In this case, the interference mitigator 781 may stop using UAD.

In one configuration, one or more of the interference reporter 779 and the interference mitigator 781 may be included in the UE 704. For example, the functionality provided by the interference reporter 779 and the interference mitigator 781 may be provided by the UE 704 in some configurations. In another configuration, one or more of the interference reporter 779 and the interference mitigator 781 may be included in the communication device(s) 783. In yet another configuration, one or more of the interference reporter 779 and the interference mitigator 781 may not be included in the UE 704 or in the communication device(s) 783.

The eNB 760 may include one or more elements or components used to communicate with the wireless communication device 702 (e.g., UE 704). For example, the eNB 760 may include one or more transceivers 764, one or more demodulators 770, one or more decoders 772, one or more encoders 786, one or more modulators 784 and an interference manager 787. For instance, one or more reception and/or transmission paths may be used in the eNB 760. For convenience, only a single transceiver 764, decoder 772, demodulator 770, encoder 786 and modulator 784 are illustrated, though multiple parallel elements 764, 772, 770, 786, 784 may be used depending on the configuration. It should be noted that the eNB 760 may be coupled to a network (e.g., the Internet, Public Switched Telephone Network (PSTN), etc.) and may serve to relay data between the wireless communication device 702 (e.g., UE 704) and the network.

The eNB transceiver 764 may include one or more receivers 766 and one or more transmitters 768. The one or more receivers 766 may receive signals from the wireless communication device 702 using one or more antennas 762. For example, the receiver 766 may receive and downconvert signals to produce one or more received signals. The one or more received signals may be provided to a demodulator 770. The one or more transmitters 768 may transmit signals to the wireless communication device 702 using one or more antennas 762. For example, the one or more transmitters 768 may upconvert and transmit one or more modulated signals.

The demodulator 770 may demodulate the one or more received signals to produce one or more demodulated signals. The one or more demodulated signals may be provided to the decoder 772. The eNB 760 may use the decoder 772 to decode signals. The decoder 772 may produce one or more decoded signals. For example, a first eNB-decoded signal may comprise received payload data 774. A second eNB-decoded signal that is provided to an interference manager 787 may comprise overhead data and/or control data. For example, the second eNB-decoded signal may provide data that may be used by the interference manager 787 to perform one or more operations. For instance, this data may include an interference report from the wireless communication device 702 regarding interference between the UE 704 and the one or more communication devices 783.

The interference manager 787 may be used to manage interference between the UE 704 and the one or more communication devices 783. For example, the interference manager 787 may generate one or more commands and/or messages for transmission to the wireless communication device 702 that may be used to control interference between the UE 704 and the one or more communication devices 783.

For instance, the interference manager 787 may generate an enable interference reporting command that is provided to the encoder 786 for transmission to the wireless communication device 702. The interference manager 787 may also generate a disable interference reporting command that is similarly provided to the encoder 786.

As illustrated, the interference manager 787 may generate an interference avoidance configuration 789. The interference avoidance configuration 789 may be a data set that specifies how the wireless communication device 702 may be configured to mitigate interference. The interference avoidance configuration 789 may be included in a start interference mitigation message that is generated by the interference manager 787 and is provided to the encoder 786 for transmission to the wireless communication device 702.

The interference manager 787 may additionally generate an explicit or implicit command to use UE autonomous denial (UAD) that may be sent to the wireless communication device 702 in a start interference mitigation message or in a separate message. The interference manager 787 may also generate an explicit or implicit command to stop using UE autonomous denial (UAD) that may be sent to the wireless communication device 702 in a stop interference mitigation message or in a separate message.

The encoder 786 may encode transmission data 788 and/or other information provided by the interference manager 787. For example, encoding the data 788 and/or other information may involve error detection and/or correction coding, mapping data to space, time and/or frequency resources (e.g., space-time block coding (STBC)) for transmission, etc. For instance, the interference manager 787 may provide information to the encoder 786, such as an enable interference reporting command, a disable interference reporting command, a start interference mitigation message (that may include the interference avoidance configuration 789, for example), a stop interference mitigation message and/or other messages. It should be noted that a command to use UE autonomous denial (UAD) may be included in the start interference mitigation message or may be sent in another message. Additionally, a command to stop using UAD may be included in a stop interference mitigation message or may be sent in another message.

The encoder 786 may provide encoded data (e.g., information) to the modulator 784. The modulator 784 may modulate the encoded data to provide one or more modulated signals to the one or more transmitters 768. The one or more transmitters 768 may upconvert and transmit the modulated signal(s) to the wireless communication device 702.

It should be noted that each of the elements or components included in the eNB 760 may be implemented in hardware, software or a combination of both. For example, the interference manager 787 may be implemented in hardware, software or a combination of both.

The communication device(s) 785 may include one or more elements or components used to communicate with the wireless communication device 702 (e.g., communication device(s) 783). For example, the communication device(s) 785 may include one or more transceivers 794, one or more demodulators 701, one or more decoders 703, one or more encoders 715 and one or more modulators 713. For instance, one or more reception and/or transmission paths may be used in the communication device(s) 785. For convenience, only a single transceiver 794, decoder 703, demodulator 701, encoder 715 and modulator 713 are illustrated, though multiple parallel elements 794, 703, 701, 715, 713 may be used depending on the configuration. It should be noted that the communication device(s) 785 may be coupled to a network (e.g., a Local Area Network (LAN), the Internet, etc.) and may serve to relay data between the wireless communication device 702 (e.g., communication device(s) 783) and the network. Examples of the communication device(s) 785 include Access Points (APs), Bluetooth devices, etc. In some configurations, the communication device(s) 785 may communicate in the ISM frequency band.

The transceiver 794 may include one or more receivers 796 and one or more transmitters 798. The one or more receivers 796 may receive signals from the wireless communication device 702 using one or more antennas 792. For example, the receiver 796 may receive and downconvert signals to produce one or more received signals. The one or more received signals may be provided to a demodulator 701. The one or more transmitters 798 may transmit signals to the wireless communication device 702 using one or more antennas 792. For example, the one or more transmitters 798 may upconvert and transmit one or more modulated signals.

The demodulator 701 may demodulate the one or more received signals to produce one or more demodulated signals. The one or more demodulated signals may be provided to the decoder 703. The communication device(s) 785 may use the decoder 703 to decode signals. The decoder 703 may produce one or more decoded signals. For example, one decoded signal may comprise received payload data 705.

The encoder 715 may encode transmission data 717 and/or other information. For example, encoding the data 717 and/or other information may involve error detection and/or correction coding, mapping data to space, time and/or frequency resources (e.g., space-time block coding (STBC)) for transmission, etc. The encoder 715 may provide encoded data to the modulator 713. The modulator 713 may modulate the encoded data to provide one or more modulated signals to the one or more transmitters 798. The one or more transmitters 798 may upconvert and transmit the modulated signal(s) to the wireless communication device 702. It should be noted that each of the elements or components included in the communication device(s) 785 may be implemented in hardware, software or a combination of both.

Some approaches for addressing interference between the UE 704 and the one or more communication devices 783 may be divided into two categories: an LTE Network-Controlled UE-Assisted (NCUA) approach and a UE Autonomous Denial (UAD) approach. In the UAD approach, the wireless communication device 702 (e.g., interference mitigator 781) may autonomously deny the transmission of LTE resources for the UE 704 that would otherwise interfere with critical short-term ISM band reception events (e.g., while the one or more communication devices 783 are performing a Bluetooth (BT) connection setup, Wi-Fi connection setup, receiving a Wi-Fi beacon, etc.). Additionally or alternatively, the wireless communication device 702 (e.g., interference mitigator 781) may autonomously deny ISM band transmissions for the one or more communication devices 783 to ensure successful reception of important LTE signaling for the UE 704.

In the NCUA approach, the wireless communication device 702 may send an interference report to the eNB 760 that provides an indication of interference and possible additional information about one or more frequencies that are interfered with, the periodicity of the interference and a potential source (e.g., Bluetooth, Wi-Fi, etc.) of the interference. The NCUA approach may use one or more of a Frequency Division Multiplexed (FDM) approach and a Time Division Multiplexed (TDM) approach to address the interference. The approach used (which may be indicated by the interference avoidance configuration 789, for example) may be determined by the information (e.g., interference report) provided by the wireless communication device 702 and possibly other network information. The TDM approach can be further divided into a hybrid automatic repeat request (HARQ) Process Reservation and discontinuous reception (DRX)-based approaches.

In one configuration of the HARQ Process Reservation-based approach, a number of LTE HARQ processes (e.g., subframes) may be reserved for the UE 704 (e.g., for LTE uplink and downlink traffic). The remaining subframes may be used to accommodate the one or more communication devices 783 (e.g., for ISM band uplink and downlink traffic).

In one DRX-based approach, two periods of time may be defined. The first period may be reserved for the UE 704 (e.g., for LTE uplink and downlink traffic). The second period may be used to accommodate the one or more communication devices 783 (for ISM band uplink and downlink traffic, for example).

There are situations where it may be useful to use a UAD approach in addition to an NCUA TDM approach to facilitate Coexistence Interference Avoidance (IDC). In one configuration of the systems and methods disclosed herein, the eNB 760 may send a command (via a dedicated radio resource control (RRC) message) to the wireless communication device 702 that enables it 702 to use UAD. Additionally or alternatively, the eNB 760 may send a command (via a dedicated RRC message) to the wireless communication device 702 that disables its 702 ability to use UAD. More detail is given below.

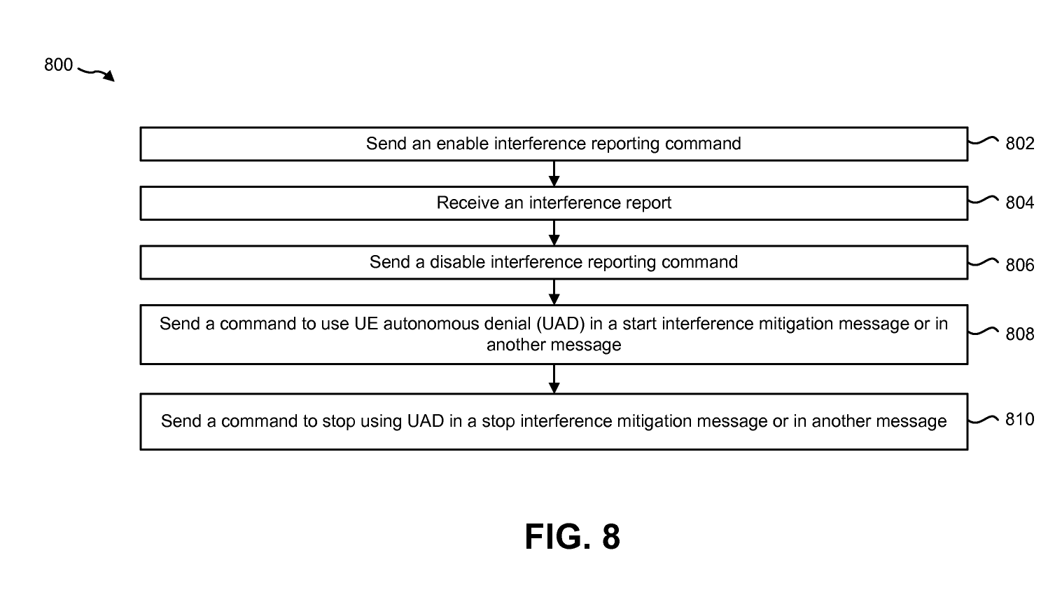

FIG. 8 is a flow diagram illustrating one configuration of a method 800 for interference control signaling by an enhanced or evolved Node B (eNB) 760. The eNB 760 may send 802 an enable interference reporting command (via an RRC message such as an RRCConnectionReconfiguration message) to the wireless communication device 702 (e.g., UE 704). The enable interference reporting command may enable the wireless communication device 702 to report the detection of interference caused by LTE uplink (UL) transmissions on ISM downlink (DL) receptions and/or ISM uplink (UL) transmissions on LTE downlink (DL) receptions (e.g., IDC interference).

The eNB 760 may receive 804 an interference report from the wireless communication device 702. For example, the eNB 760 may receive (via an RRC message) an interference report (e.g., a MeasurementReport) regarding the detection of interference (caused by IDC interference, for instance). The interference report may contain additional information about the interfered with frequency (or frequencies), the periodicity of the interference and/or the potential source of the interference (e.g., Wi-Fi or BT). The eNB 760 may generate an interference avoidance configuration (e.g., data set) 789 based on the interference report.

The eNB 760 may send 806 a disable interference reporting command to the wireless communication device 702. For example, the eNB 706 may send the disable interference reporting command (via an RRC message) to the wireless communication device 702 (e.g., UE 704) that disables interference reporting on the wireless communication device 702.

The eNB 760 may send 808 a command to use UE autonomous denial (UAD) with a start interference mitigation message or in another message. In one configuration, for example, the eNB 760 may send (via an RRC message) a start interference mitigation message to the wireless communication device 702. The start interference mitigation message may include an interference avoidance configuration 789 (e.g., data set) that configures the wireless communication device 702 (e.g., UE 704) and triggers it 702 to start an NCUA TDM interference mitigation procedure (e.g., IDC interference mitigation procedure). The interference avoidance configuration 789 (e.g., data set) may enable a DRX-based procedure or a HARQ Process Reservation-based procedure. Associated with the DRX procedure and the HARQ procedure may be an ability of the wireless communication device 702 (e.g., UE 704) to use UAD.

The eNB 760 may send 808 a command to use UAD. In one example, the command to use UAD may be signaled implicitly by sending an RRC message containing the start interference mitigation message. In another example, the command to use UAD may be signaled explicitly by sending a command in the same RRC message containing the start interference mitigation message. In yet another example, the command to use UAD may be signaled explicitly by sending another message. This other message may be an RRC message other than the message containing the start interference mitigation message.

The eNB 760 may send 810 a command to stop using UAD with a stop interference mitigation message or in another message. In one configuration, for example, an eNB 760 may send (via an RRC message) a stop interference mitigation message to the wireless communication device 702. The stop interference mitigation message may include a command to stop the NCUA TDM interference mitigation procedure (e.g., IDC interference mitigation procedure). This command may disable a DRX-based procedure or a HARQ Process Reservation-based procedure. Associated with the DRX procedure and the HARQ procedure may be an ability of the wireless communication device 702 (e.g., UE 704) to use UAD.

The eNB 760 may send 810 a command to stop using UAD. In one example, the command to stop using UAD may be signaled implicitly by sending an RRC message containing the stop interference mitigation message. In another example, the command to stop using UAD may be signaled explicitly by sending a command in the same RRC message containing the stop interference mitigation message. In yet another example, the command to stop using UAD may be signaled explicitly by sending another message. This other message may be an RRC message other than the message containing the stop interference mitigation message.

It should be noted that in some configurations, the wireless communication device 702 may be pre-configured (at a time of manufacture, for example) with a default setting that either enables or disables the wireless communication device's 702 ability to use UAD. However, the eNB 760 may send either an implicit or explicit command that overrides the default setting that specifies the wireless communication device's 702 ability to use UAD.

Thus, the systems and methods disclosed herein may provide a procedure by which an eNB 760 may know and control the operating states of the wireless communication device 702 with respect to the use of UAD during interference mitigation (e.g., NCUA TDM IDC interference mitigation). This may prevent potential inefficiencies in protocol resource allocations.

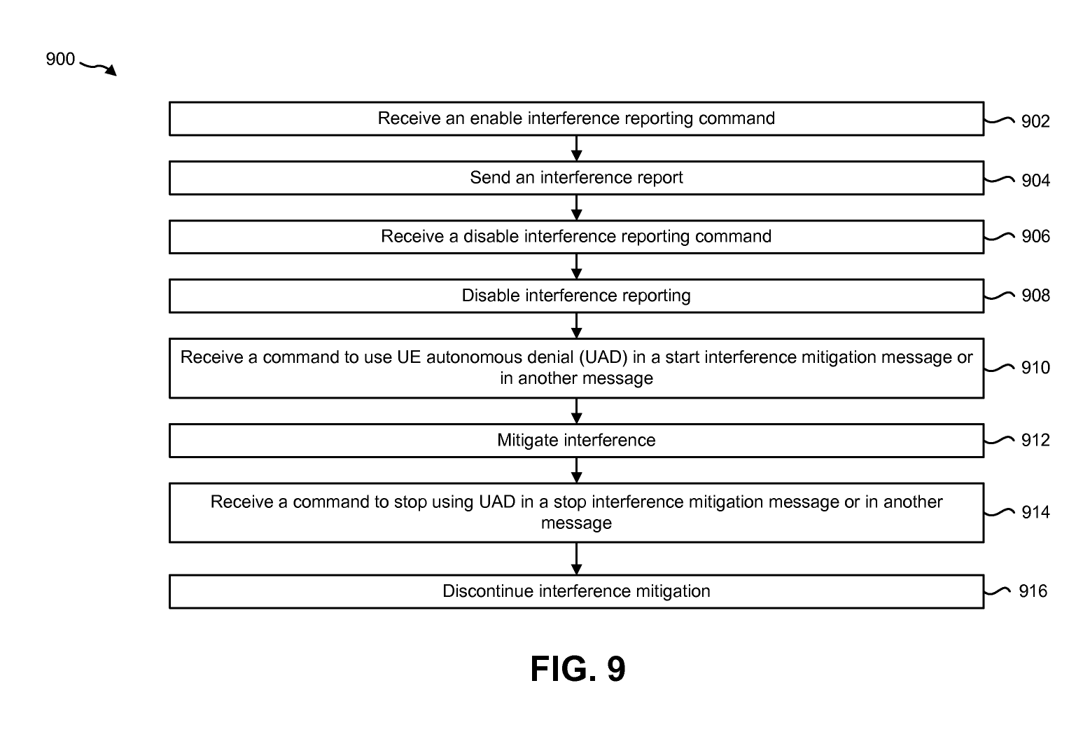

FIG. 9 is a flow diagram illustrating one configuration of a method 900 for using interference control signaling on a wireless communication device. A wireless communication device 702 may receive 902 an enable interference reporting command from the eNB 760. For example, the wireless communication device 702 may receive the enable interference reporting command via an RRC message such as an RRCConnectionReconfiguration message. The enable interference reporting command may enable the wireless communication device 702 to report the detection of interference caused by LTE uplink (UL) transmissions on ISM downlink (DL) reception and/or ISM uplink (UL) transmissions on LTE downlink (DL) reception (e.g., IDC interference).

The wireless communication device 702 may thus enable interference reporting. For example, the interference reporter 779 may determine whether there may be interference between the UE 704 and the one or more communication devices 783. In one configuration, the interference reporter 779 may receive communication information from the UE communication controller 712 and the communication controller 744 of each communication device 783. The communication information may include, for example, the communication frequency or frequencies, communication timing or scheduling, communication periodicity, etc. The interference reporter 779 may use this information (and the source (e.g., communication device 783) of the information) to determine whether any interference has and/or may occur. This may be used to generate an interference report that may be provided to the encoder 716 of the UE 704.

The wireless communication device 702 (e.g., UE 704) may send 904 an interference report to the eNB 760. For example, the UE 704 may send 904 (via an RRC message) a report (e.g., a MeasurementReport) regarding the detection of interference (caused by IDC interference, for example) to the eNB 760. The interference report may contain additional information about the interfered with frequency (or frequencies), the periodicity of the interference and/or the potential source of the interference (e.g., Wi-Fi or BT).

The wireless communication device 702 may receive 906 a disable interference reporting command from the eNB 760. For example, the wireless communication device 702 (e.g., UE 704) may receive the disable interference reporting command (via an RRC message) from the eNB 760.

The wireless communication device 702 may disable 908 interference reporting. For instance, the interference reporter 779 may be disabled upon receipt of the disable interference reporting command that may be provided by the UE 704 decoder 708.

The wireless communication device 702 may receive 910 a command to use UE autonomous denial (UAD) with a start interference mitigation message or in another message. In one configuration, for example, the wireless communication device 702 may receive (via an RRC message) a start interference mitigation message from the eNB 760. The start interference mitigation message may include an interference avoidance configuration 789 (e.g., data set) that configures the wireless communication device 702 (e.g., UE 704) and triggers it 702 to start an NCUA TDM interference mitigation procedure (e.g., IDC interference mitigation procedure). The interference avoidance configuration 789 (e.g., data set) may enable a DRX-based procedure or a HARQ Process Reservation-based procedure. Associated with the DRX procedure and the HARQ procedure may be an ability of the wireless communication device 702 (e.g., UE 704) to use UAD.

The wireless communication device 702 may receive 910 a command to use UAD. In one example, the command to use UAD may be signaled implicitly by receiving an RRC message containing the start interference mitigation message. In another example, the command to use UAD may be signaled explicitly by receiving a command in the same RRC message containing the start interference mitigation message. In yet another example, the command to use UAD may be signaled explicitly by receiving another message. This other message may be an RRC message other than the message containing the start interference mitigation message.

The wireless communication device 702 may mitigate 912 interference. For example, the wireless communication device 902 may use a received interference avoidance configuration 789 to mitigate 912 interference. For instance, the interference mitigator 781 may use an NCUA approach such as an FDM approach and/or a TDM approach to mitigating interference based on the interference avoidance configuration 789. In one configuration, the interference avoidance configuration 789 may specify a TDM approach such as a DRX-based approach or a HARQ process reservation approach.

In one configuration, NCUA interference mitigation may be managed by the interference mitigator 781. For example, the interference mitigator 781 may send commands to the UE communication controller 712 and/or to the communication controller 744 to coordinate communications. This may be done by reserving certain subframes or reserving periods for communication for the UE 704 or the one or more communication devices 783.

Additionally or alternatively, the wireless communication device 702 may mitigate 912 interference using UE autonomous denial (UAD). For example, the wireless communication device 702 (e.g., interference mitigator 781) may autonomously deny the transmission of LTE resources for the UE 704 that would otherwise interfere with critical short-term ISM band reception events (e.g., while the one or more communication devices 783 are performing a Bluetooth (BT) connection setup, Wi-Fi connection setup, receiving a Wi-Fi beacon, etc.). Additionally or alternatively, the wireless communication device 702 (e.g., interference mitigator 781) may autonomously deny ISM band transmissions for the one or more communication devices 783 to ensure successful reception of particular (e.g., “important”) LTE signaling for the UE 704.

In one configuration, UAD may be managed by the interference mitigator 781. For example, the interference mitigator 781 may send commands to the UE communication controller 712 and/or to the communication controller 744 to deny certain communications.

The wireless communication device 702 may receive 914 a command to stop using UAD with a stop interference mitigation message or in another message. In one configuration, for example, the wireless communication device 702 may receive (via an RRC message) a stop interference mitigation message from the eNB 760. The stop interference mitigation message may include a command to stop the NCUA TDM interference mitigation procedure (e.g., IDC interference mitigation procedure). This command may disable a DRX-based procedure or a HARQ Process Reservation-based procedure. Associated with the DRX procedure and the HARQ procedure may be an ability of the wireless communication device 702 (e.g., UE 704) to use UAD.

The wireless communication device 702 may receive 914 a command to stop using UAD. In one example, the command to stop using UAD may be signaled implicitly by receiving an RRC message containing the stop interference mitigation message. In another example, the command to stop using UAD may be signaled explicitly by receiving a command in the same RRC message containing the stop interference mitigation message. In yet another example, the command to stop using UAD may be signaled explicitly by receiving another message. This other message may be an RRC message other than the message containing the stop interference mitigation message.

The wireless communication device 702 may discontinue 916 interference mitigation. For example, the wireless communication device 702 may stop using NCUA interference mitigation procedures and/or may stop using UAD interference mitigation procedures. For instance, the interference mitigator 781 may be disabled based on a stop interference mitigation message provided by the UE 704 decoder 708.

It should be noted that in some configurations, the wireless communication device 702 may be pre-configured (at a time of manufacture, for example) with a default setting that either enables or disables the wireless communication device's 702 ability to use UAD. However, the wireless communication device 702 may receive either an implicit or explicit command that overrides the default setting that specifies the wireless communication device's 702 ability to use UAD.

It should be noted that a wireless communication device may generally mitigate interference between a UE included in the wireless communication device and another communication device (e.g., STA) included in the wireless communication device based on interference control signaling. In one configuration, for example, a wireless communication device may perform both the method 200 illustrated in FIG. 2 and the method 900 illustrated in FIG. 9. For instance, receiving 910 a command may be used to select and/or perform the interference mitigation approach described in connection with FIG. 2.

It should also be noted that an eNB may generally communicate interference control signaling with a UE in order to control interference between a UE included in the wireless communication device and another communication device (e.g., STA, BT, etc.) included in the wireless communication device. In one configuration, for example, an eNB may transmit signals to and/or receive signals from a wireless communication device to control interference. For instance, the eNB may perform both the method 300 illustrated in FIG. 3 and the method 800 illustrated in FIG. 8. In one configuration, sending 808 a command may be used to select the interference mitigation approach described in connection with FIG. 2.

As used herein, the term “interference signaling” may refer to one or more of the signals and/or messages disclosed herein that is communicated between a wireless communication device and an eNB. The term “interference signaling” may additionally or alternatively refer to one or more of the signals and/or messages communicated between a wireless communication device and another communication device (e.g., AP). Examples of interference control signaling include the USP MAC CE, the UUP MAC CE, a command to use UAD, a command to stop using UAD, an enable interference reporting command, an interference report, a disable interference reporting command, a start interference mitigation message, a stop interference mitigation message, etc.

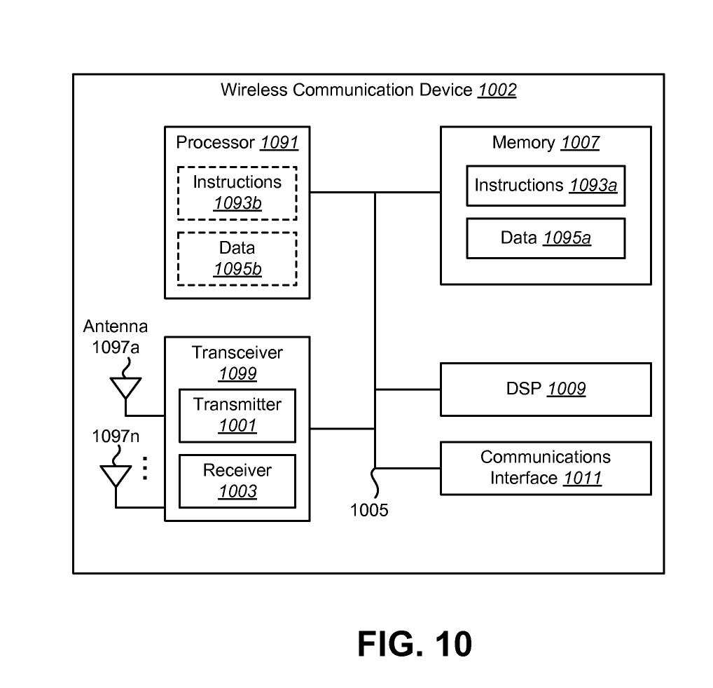

FIG. 10 illustrates various components that may be utilized in a wireless communication device 1002. The wireless communication device 1002 may be utilized as the wireless communication devices 102, 702 described above. The wireless communication device 1002 includes a processor 1091 that controls operation of the wireless communication device 1002. The processor 1091 may also be referred to as a CPU. Memory 1007, which may include read-only memory (ROM), random access memory (RAM), a combination of the two or any type of device that may store information, provides instructions 1093a and data 1095a to the processor 1091. A portion of the memory 1007 may also include non-volatile random access memory (NVRAM). Instructions 1093b and data 1095b may also reside in the processor 1091. Instructions 1093b and/or data 1095b loaded into the processor 1091 may also include instructions 1093a and/or data 1095a from memory 1007 that were loaded for execution or processing by the processor 1091. The instructions 1093b may be executed by the processor 1091 to implement one or more of the methods 200, 900 disclosed herein.

The wireless communication device 1002 may also include a housing that contains one or more transmitters 1001 and one or more receivers 1003 to allow transmission and reception of data. The transmitter(s) 1001 and receiver(s) 1003 may be combined into one or more transceivers 1099. One or more antennas 1097a-n are attached to the housing and electrically coupled to the transceiver 1099.

The various components of the wireless communication device 1002 are coupled together by a bus system 1005, which may include a power bus, a control signal bus, and a status signal bus, in addition to a data bus. However, for the sake of clarity, the various buses are illustrated in FIG. 10 as the bus system 1005. The wireless communication device 1002 may also include a digital signal processor (DSP) 1009 for use in processing signals. The wireless communication device 1002 may also include a communications interface 1011 that provides user access to the functions of the wireless communication device 1002. The wireless communication device 1002 illustrated in FIG. 10 is a functional block diagram rather than a listing of specific components.

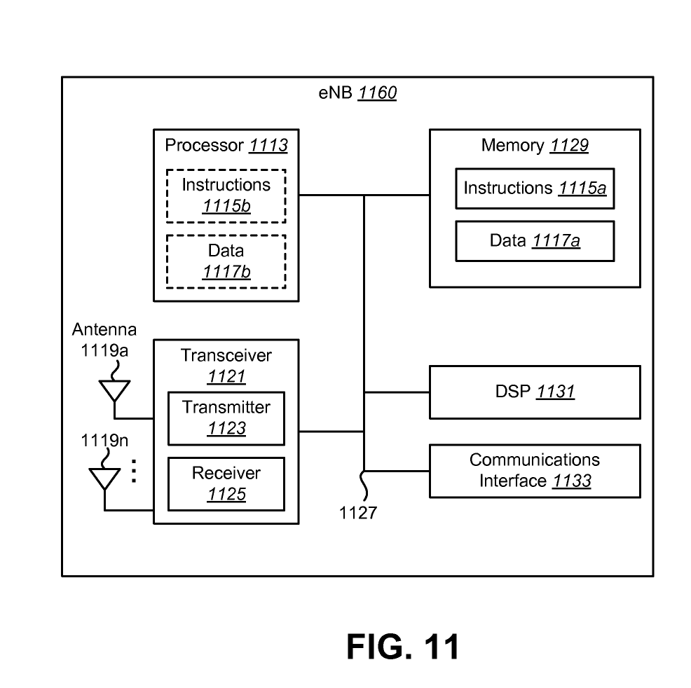

FIG. 11 illustrates various components that may be utilized in an enhanced or evolved Node B (eNB) 1160. The eNB 1160 may be utilized as one or more of the eNBs 160, 760 illustrated previously. The eNB 1160 may include components that are similar to the components discussed above in relation to the wireless communication device 1002, including a processor 1113, memory 1129 that provides instructions 1115a and data 1117a to the processor 1113, instructions 1115b and data 1117b that may reside in or be loaded into the processor 1113, a housing that contains one or more transmitters 1123 and one or more receivers 1125 (which may be combined into one or more transceivers 1121), one or more antennas 1119a-n electrically coupled to the transceiver(s) 1121, a bus system 1127, a DSP 1131 for use in processing signals, a communications interface 1133 and so forth.

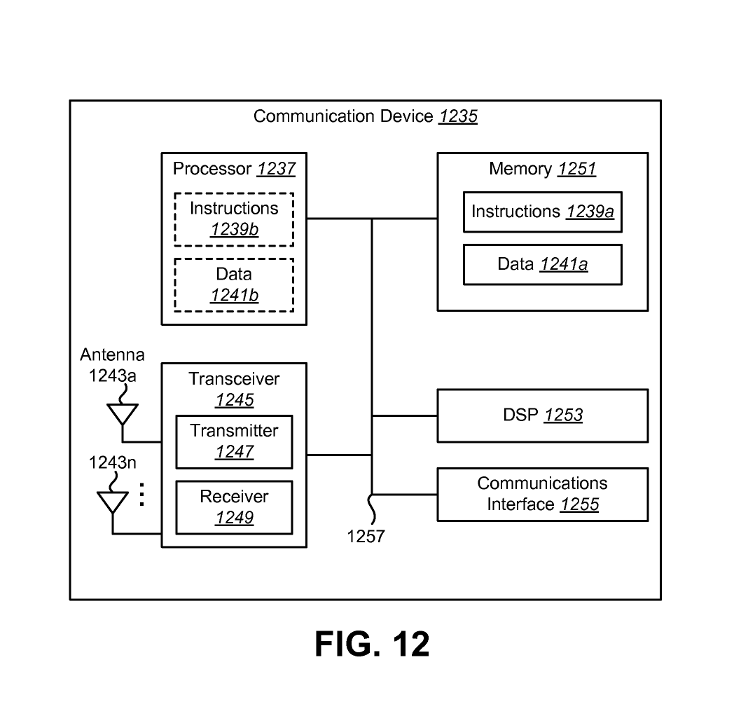

FIG. 12 illustrates various components that may be utilized in a communication device 1235. The communication device 1235 may be utilized as one or more of the communication devices 785 and the Access Point (AP) 190 illustrated previously. The communication device 1235 may include components that are similar to the components discussed above in relation to the eNB 1160, including a processor 1237, memory 1251 that provides instructions 1239a and data 1241a to the processor 1237, instructions 1239b and data 1241b that may reside in or be loaded into the processor 1237, a housing that contains one or more transmitters 1247 and one or more receivers 1249 (which may be combined into one or more transceivers 1245), one or more antennas 1243a-n electrically coupled to the transceiver(s) 1245, a bus system 1257, a DSP 1253 for use in processing signals, a communications interface 1255 and so forth.

The term “computer-readable medium” refers to any available medium that can be accessed by a computer or a processor. The term “computer-readable medium,” as used herein, may denote a computer- and/or processor-readable medium that is non-transitory and tangible. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

It should be noted that one or more of the methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

Each of the methods disclosed herein comprises one or more steps or actions for achieving the described method. The method steps and/or actions may be interchanged with one another and/or combined into a single step without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A wireless communication device configured for coordinating dynamic communication periods, comprising:
a processor;
memory in electronic communication with the processor;
instructions stored in the memory, the instructions being executable to:
receive a medium access control (MAC) control element (CE) from an enhanced Node B (eNB); and
start a User Equipment (UE) unscheduled period.

2. The wireless communication device of claim 1, wherein the instructions are further executable to end the UE unscheduled period based on one selected from the group consisting of sending a Scheduling Request (SR), a UE unscheduled period timer and whether a station (STA) has more data to send or receive.

3. The wireless communication device of claim 1, wherein the instructions are further executable to:
receive a signal from an Access Point (AP) during a station (STA) awake state;
determine whether the STA awake state has ended;
determine a UE scheduled period value if the STA awake state has ended;
receive a signal from an enhanced Node B (eNB) if the STA awake state has ended; and
send a UE scheduled period medium access control (MAC) control element (CE) if the STA awake state has ended.

4. The wireless communication device of claim 3, wherein if the STA awake state has ended, the instructions are further executable to:
determine a Wi-Fi sleep period value;
start a Wi-Fi sleep period;
determine whether the Wi-Fi sleep period has ended; and
start another STA awake state if the Wi-Fi sleep period has ended.

5. The wireless communication device of claim 4, wherein determining whether the Wi-Fi sleep period has ended is based on one selected from the group consisting of whether a UE unscheduled period MAC CE is received and starting a UE unscheduled period timer.

6. The wireless communication device of claim 1, wherein the instructions are further executable to send a UE scheduled period MAC CE.

7. An enhanced Node B (eNB) configured for controlling dynamic communication periods, comprising:
a processor;
memory in electronic communication with the processor;
instructions stored in the memory, the instructions being executable to:
transmit a User Equipment (UE) unscheduled period medium access control (MAC) control element (CE).

8. The eNB of claim 7, wherein the instructions are further executable to receive a UE scheduled period MAC CE.

9. The eNB of claim 7, wherein the instructions are further executable to determine whether an eNB unscheduled period has begun.

10. The eNB of claim 7, wherein the instructions are further executable to avoid scheduling a UE during an eNB unscheduled period.

11. The eNB of claim 7, wherein the instructions are further executable to determine whether an eNB unscheduled period has ended.

12. An enhanced Node B (eNB) configured for interference control signaling, comprising:
a processor;
memory in electronic communication with the processor;
instructions stored in the memory, the instructions being executable to:
send an enable interference reporting command;
receive an interference report;
send a disable interference reporting command; and
send a command to use User Equipment (UE) autonomous denial (UAD).

13. The eNB of claim 12, wherein the command to use UAD is sent by one selected from the group consisting of sending the command implicitly in a message containing a start interference mitigation message, sending the command explicitly in the message containing the start interference mitigation message and sending the command explicitly in a message not containing the start interference mitigation message.

14. The eNB of claim 12, wherein the instructions are further executable to send a command to stop using UAD.

15. The eNB of claim 14, wherein the command to stop using UAD is sent by one selected from the group consisting of sending the command implicitly in a message containing a stop interference mitigation message, sending the command explicitly in the message containing the stop interference mitigation message and sending the command explicitly in a message not containing the stop interference mitigation message.

16. A wireless communication device configured for using interference control signaling, comprising:
a processor;
memory in electronic communication with the processor;
instructions stored in the memory, the instructions being executable to:
receive an enable interference reporting command;
send an interference report;
receive a disable interference reporting command; and
receive a command to use User Equipment (UE) autonomous denial (UAD).

17. The wireless communication device of claim 16, wherein the command to use UAD is received by one selected from the group consisting of receiving the command implicitly in a message containing a start interference mitigation message, receiving the command explicitly in the message containing the start interference mitigation message and receiving the command explicitly in a message not containing the start interference mitigation message.

18. The wireless communication device of claim 16, wherein the instructions are further executable to receive a command to stop using UAD.

19. The wireless communication device of claim 18, wherein the command to stop using UAD is received by one selected from the group consisting of receiving the command implicitly in a message containing a stop interference mitigation message, receiving the command explicitly in the message containing the stop interference mitigation message and receiving the command explicitly in a message not containing the stop interference mitigation message.

20. A method for coordinating dynamic communication periods on a wireless communication device, comprising:
receiving a medium access control (MAC) control element (CE) from an enhanced Node B (eNB); and
starting a User Equipment (UE) unscheduled period.

21. The method of claim 20, further comprising ending the UE unscheduled period based on one selected from the group consisting of sending a Scheduling Request (SR), a UE unscheduled period timer and whether a station (STA) has more data to send or receive.

22. The method of claim 20, further comprising:
receiving a signal from an Access Point (AP) during a station (STA) awake state;
determining whether the STA awake state has ended;
determining a UE scheduled period value if the STA awake state has ended;
receiving a signal from an enhanced Node B (eNB) if the STA awake state has ended; and
sending a UE scheduled period medium access control (MAC) control element (CE) if the STA awake state has ended.

23. The method of claim 22, wherein if the STA awake state has ended, the method further comprises:
determining a Wi-Fi sleep period value;
starting a Wi-Fi sleep period;
determining whether the Wi-Fi sleep period has ended; and
starting another STA awake state if the Wi-Fi sleep period has ended.

24. The method of claim 23, wherein determining whether the Wi-Fi sleep period has ended is based on one selected from the group consisting of whether a UE unscheduled period MAC CE is received and starting a UE unscheduled period timer.

25. The method of claim 20, further comprising sending a UE scheduled period MAC CE.

26. A method for controlling dynamic communication periods by an enhanced Node B (eNB), comprising:
transmitting a User Equipment (UE) unscheduled period medium access control (MAC) control element (CE).

27. The method of claim 26, further comprising receiving a UE scheduled period MAC CE.

28. The method of claim 26, further comprising determining whether an eNB unscheduled period has begun.

29. The method of claim 26, further comprising avoiding scheduling a UE during an eNB unscheduled period.

30. The method of claim 26, further comprising determining whether an eNB unscheduled period has ended.

31. A method for interference control signaling by an enhanced Node B (eNB), comprising:
sending an enable interference reporting command;
receiving an interference report;
sending a disable interference reporting command; and
sending a command to use User Equipment (UE) autonomous denial (UAD).

32. The method of claim 31, wherein the command to use UAD is sent by one selected from the group consisting of sending the command implicitly in a message containing a start interference mitigation message, sending the command explicitly in the message containing the start interference mitigation message and sending the command explicitly in a message not containing the start interference mitigation message.

33. The method of claim 31, further comprising sending a command to stop using UAD.

34. The method of claim 33, wherein the command to stop using UAD is sent by one selected from the group consisting of sending the command implicitly in a message containing a stop interference mitigation message, sending the command explicitly in the message containing the stop interference mitigation message and sending the command explicitly in a message not containing the stop interference mitigation message.

35. A method for using interference control signaling on a wireless communication device, comprising:
receiving an enable interference reporting command;
sending an interference report;
receiving a disable interference reporting command; and
receiving a command to use User Equipment (UE) autonomous denial (UAD).

36. The method of claim 35, wherein the command to use UAD is received by one selected from the group consisting of receiving the command implicitly in a message containing a start interference mitigation message, receiving the command explicitly in the message containing the start interference mitigation message and receiving the command explicitly in a message not containing the start interference mitigation message.

37. The method of claim 35, further comprising receiving a command to stop using UAD.

38. The method of claim 37, wherein the command to stop using UAD is received by one selected from the group consisting of receiving the command implicitly in a message containing a stop interference mitigation message, receiving the command explicitly in the message containing the stop interference mitigation message and receiving the command explicitly in a message not containing the stop interference mitigation message.

39. A wireless communication device configured for interference control signaling, comprising:
a processor;
memory in electronic communication with the processor;
instructions stored in the memory, the instructions being executable to:
mitigate interference between a User Equipment (UE) included in the wireless communication device and another communication device included in the wireless communication device based on interference control signaling.

40. An enhanced Node B (eNB) configured for interference control signaling, comprising:
a processor;
memory in electronic communication with the processor;
instructions stored in the memory, the instructions being executable to:
communicate interference control signaling with a User Equipment (UE) to control interference between the UE included in a wireless communication device and another communication device included in the wireless communication device.
